(19) United States
(12) Patent Application Publication
(10) Pub. No.: US 2002/0097041 A1
(43) Pub. Date: Jul. 25, 2002

(54) Detecting rotation of a physical object using gravity

(75) Inventors: Marcos R. Vescovi, Stanford, CA (US); Christopher Harold Schmidt, Fairfax, CA (US)

Correspondence Address: BEYER WEAVER & THOMAS LLP, P.O. BOX 778, BERKELEY, CA, 94704-0778, US

(73) Assignee: Lego Systems, Inc.

(21) Appl. No.: 09/732,118

(22) Filed: Dec. 6, 2000

Related U.S. Application Data
(60) Provisional application No. 60/169,746, filed on Dec. 8, 1999.

(51) Int. Cl. G01B 7/14

(52) U.S. Cl. 324/207.17

(57) ABSTRACT

A rotation detection system for detecting an orientation of a physical object is disclosed. A rotation detection object is adapted for being movably coupled to a physical object, where at least a portion of the rotation detection object is moveable among two or more positions in relation to the physical object in response to gravitational pull. A rotation detection mechanism detects an orientation of the physical object when the at least a portion of the rotation detection object moves from a first one of the two or more positions to a second one of the two or more positions.

### CROSS REFERENCE TO RELATED APPLICATIONS

This application is related to U.S. patent application Ser. No. 09/018,023 filed Feb. 2, 1998 entitled “Computer Method and Apparatus for Interacting with a Physical System” by Piernot, et al., which is herein incorporated by reference.

This application is also related to U.S. patent application Ser. No. 09/144,951 filed Sep. 1, 1998 entitled “Detecting Physical Object States Using Electromagnetic Sensors” by Vescovi, et al., Attorney Docket No. INT1P021, which is herein incorporated by reference.

This application is also related to U.S. Provisional Application No. 60/169746 filed Dec. 8, 1999 entitled “Detecting Rotation of a Physical Object Using Gravity” by Vescovi, et al., which is herein incorporated by reference.

### BACKGROUND OF THE INVENTION

This invention relates generally to a position detection system and computer methods for detecting physical objects within such position detection system. More specifically, it is related to a computer system that is implemented to detect physical objects within a physical game board or a physical toy for the purpose of interfacing with such computer system.

With the prevalence of home computers, an increasingly important goal within the game industry is to design a game system that incorporates the advantages of traditional board games and advantages of video or computer games. Such combined board game systems should generally be capable of detecting the presence of playing pieces or physical objects at different locations on the game board. Preferably, they should also identify other attributes, besides position, of the physical pieces.

Various type of computer games that interface with physical objects are described in British Patent Application Number PCT/US95/10096 filed by Superdimension Inc, published on Feb. 8, 1996 (Herein referred to as “Superdimension”). For example, Superdimension refers to British Patent 2,103,943 as describing a sensing board and resonating pieces. The pieces include resonators that may be sensed by circuits in the board associated with particular position “cells.” The resonators are sensed by electromagnetic induction. Due to coupling between the coils in the playing pieces and the coils in the board, signals fed to the board stimulate the resonators and pick up a resonant signal that is produced by the resonators. Since different pieces have different resonators that are stimulated at different resonant frequencies, different pieces may be identified based on the frequency of the resonant signal that is picked up in a particular cell on the board.

The board incorporates two groups of circuits, each group having a circuit associated with each cell. One group of cells stimulates the resonators in any pieces on the cells by transmitting electromagnetic signals and the other group receives signals produced by the resonators in the cells in response to the stimulation. The coils in each group are interconnected and are individually addressable via a diode associated with each coil.

To determine the position of a particular piece on a cell, a pulse of electric current is supplied to the simulating coil of the cell, whereby a rapid change in current at the trailing end of the pulse results in oscillation of the resonator in the piece situated at the cell at its resonant frequency. The resonant oscillation induces a current signal in the sensing coil associated with the cell which signal is amplified and thresholded. For signals greater than the threshold, the oscillation frequency is measured to yield a corresponding digital signal. When a cell is empty, i.e. it does not accommodate a piece, there is no resonant “ringing” and, therefore, the number of transitions is detectably low. In sum, this game system can only sense a position and a frequency dependent identity of the game piece.

Superdimension further describes other patents describing position sensing boards, some of which are capable of differentiating between different playing pieces, based on their individual resonating frequencies. Sensing of positional attributes of playing pieces and reacting accordingly is also performed in pinball machines, which sense the position of the pinball using a remote sensor. A ski-game, disclosed in patent SU 844011, uses photocells to detect whether ski-figure playing pieces are correctly located on a ski track and keeps score.

U.S. Pat. No. 5,169,516 discloses an interactive action toy system, in which two toy figures react to each other based on a sensed engagement position for both toys. SE 7812190, U.S. Pat. No. 4,341,385, GB 2237514, and U.S. Pat. No. 5,088,928 disclose computer games wherein a computer reacts to the position and/or previous position of a playing piece on a physical board by playing sounds and/or video graphics.

Although the above described game systems provide adequate game piece interaction for the user, these games only provide a limited number of ways to manipulate pieces, wherein the manipulation is detected by the position sensors. That is, these games only allow the user to select a type of piece and a position of the selected piece. For example, some sensing systems are incapable of detecting certain other object states, such as a z position of the game piece. Thus, the user may only move the piece within a two dimensional plane. By way of another example, some sensing systems are incapable of detecting rotation or tilt of a game piece.

Additionally, since conventional game systems identify pieces based on their resonating frequency, the number of game pieces is necessarily limited by the number of resonating frequencies that are allowed by the particular sensing technology. For example, if a position sensing system only allows 64 different resonant frequencies, the game is limited to 64 types of pieces.

Thus, there is a need for an improved game system and a method for detecting a wide range of object states of physical objects, such as rotation, within a position detection system. More particularly, it would be beneficial if an improved mechanism for detecting an angle and direction of rotation of a physical object could be implemented.

### SUMMARY OF THE INVENTION

To achieve the foregoing and other objects and according to the purpose of the present invention, a method and apparatus for detecting an angle of rotation of a physical object are disclosed. This is accomplished, in part, through the use of one or more rotation detection objects capable of detecting an orientation of a physical object when it is rotated about an axis of rotation. It is important to note that the rotation detection object functions in response to gravitational pull when the physical object is rotated.

According to one aspect of the invention, a rotation detection system for detecting an angle of rotation of a physical object includes a rotation detection object adapted for being movably coupled to a physical object, where at least a portion of the rotation detection object is moveable among two or more positions in relation to the physical object in response to gravitational pull. In addition, the rotation detection system includes a rotation detection mechanism for detecting an orientation of the physical object (e.g., one or more angles of rotation of the physical object) when the at least a portion of the rotation detection object moves from a first one of the two or more positions to a second one of the two or more positions.

According to another aspect of the invention, the rotation detection system includes a first rotation detection object and a second rotation detection object, where at least a portion of the second rotation detection object is moveable among two or more positions in relation to the first rotation detection object in response to gravitational pull when the physical object is rotated about an axis of rotation. In addition, the rotation detection system further includes a detection mechanism for detecting an orientation of the physical object from the movement of the at least a portion of the second rotation detection object in relation to the first rotation detection object.

The orientation of the physical object may indicate, for example, that the physical object is upright, turned upside down, turned left, turned right, or tilted in a specific direction. The orientation may also indicate one or more angles of rotation. The one or more angles of rotation may be detected directly or indirectly. For instance, the one or more angles or rotation may be indirectly ascertained through the use of a position detection mechanism adapted for detecting a coordinate of the rotation detection object when the physical object is rotated. A rotation detection mechanism then translates the coordinate of the rotation detection object to one or more angles of rotation of the physical object.

According to one aspect of the invention, the rotation detection object includes a resonator. In addition, a platform includes a transmitter that is arranged to output an excitation signal to the resonator. The position detection mechanism detects a coordinate of the resonator (e.g., via a resonator signal emitted by the resonator) when the transmitter outputs the excitation signal. The rotation detection object and resonator may be implemented in a variety of ways. For instance, the rotation detection object may be implemented in the form of a pendulum, a bowl shaped rotation detection object holding a resonator, a cavity in which a resonator is placed, or an elongated member on which a resonator may slide in response to rotation of an associated physical object.

While the present invention may be implemented using a platform in combination with one or more resonators that are arranged to output a resonator signal when an excitation signal with a predetermined frequency range is received by the resonator, the present invention may be implemented using any means which will enable the degree of rotation of the physical object to be detected using gravity. Thus, although the present invention is described as being implemented with electromagnetic sensing technology, any suitable sensing technology may be implemented, such as a video camera detection system.

The rotation detection system of the present invention may be used alone or in combination with other detection mechanisms. As one example, the rotation detection system may be used in combination with identity detection mechanisms that are capable of detecting the identity of the object being rotated. As another example, the rotation detection system may be used in combination with position detection mechanisms that are capable of detecting a position of a physical object within a coordinate system.

The present invention may be advantageously used to ascertain a degree and direction of rotation of a physical object. This is accomplished through the use of one or more rotation detection objects (e.g., platform, resonator) capable of detecting rotational movement of a physical object, where this movement is detected using gravity. Accordingly, the rotation detection system of the present invention is relatively low in cost to produce as well as to use.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 shows a position detection system in accordance with one embodiment of the present invention.

FIG. 2 conceptually illustrates the software operating in Macromedia Director portion of the application program of FIG. 1 in accordance with one embodiment of the present invention.

FIG. 3 illustrates the operation of the SDK of FIG. 1 in accordance with one embodiment of the present invention.

FIG. 4 is a diagrammatic side view of a physical object and associated resonator that may be used to determine an identity of the physical object in accordance with one embodiment of the present invention.

FIG. 5A is a diagrammatic top view of a physical object and a plurality of resonators that may be used to determine a coded identity of the physical object in accordance with one embodiment of the present invention.

FIG. 5B is a diagrammatic side view of a pegboard type mechanism for detecting identity in accordance with one embodiment of the present invention.

FIG. 6A is a diagrammatic side view of a door bolt type configuration for detecting an identity of a physical object in accordance with one embodiment of the present invention.

FIG. 6B is a diagrammatic side view of the physical object of FIG. 6A in accordance with one embodiment of the present invention.

FIG. 6C is a top view of the slot of FIG. 6A in accordance with one embodiment of the present invention.

FIG. 7A is a top view of a toy closet in accordance with one embodiment of the present invention.

FIG. 7B is a side view perspective of the closet of FIG. 7A in accordance with one embodiment of the present invention.

FIG. 8A is a diagrammatic perspective view of a physical object having a lever in accordance with one embodiment of the present invention.

FIG. 8B is a diagrammatic perspective view of a physical object having a rotatable knob or screw in accordance with one embodiment of the present invention.

FIG. 9A is a perspective view of a six-sided die having three associated resonators for determining die position in accordance with one embodiment of the present invention.

FIG. 9B is a perspective view of a six-sided die having two associated resonators for determining die position in accordance with one embodiment of the present invention.

FIG. 10A represents a mechanism for detecting a weight of a physical object in accordance with one embodiment of the present invention.

FIG. 10B represents a mechanism for measuring a length of a physical object in accordance with one embodiment of the present invention.

FIGS. 11A through 11C represent various mechanisms for detecting movement of various air-pumping physical objects in accordance with one embodiment of the present invention.

FIG. 12A represents a mechanism for detecting inflation and deflation of a balloon type physical object in accordance with one embodiment of the present invention.

FIG. 12B shows a mechanism for detecting a state of a pull-cord type physical object in accordance with one embodiment of the present invention.

FIG. 13 represents a mechanism for detecting a slider state of a lever of a physical object and for detecting a rotation state of the physical object in accordance with one embodiment of the present invention.

FIG. 14 illustrates a mechanism for detecting a state of a pair of levers that may be moved together and apart in accordance with one embodiment of the present invention.

FIG. 15 shows a mechanism for detecting a user's “finger-walking” movement in accordance with one embodiment of the present invention.

FIGS. 16A through 16C represent various rotary mechanisms for detecting a state of various types of physical objects in accordance with one embodiment of the present invention.

FIG. 17A through 17C represent various mechanisms for detecting states of various handle type physical objects in accordance with one embodiment of the present invention.

FIG. 18 is a diagram illustrating the use of a mechanism for detecting an angle of rotation in accordance with one embodiment of the present invention.

FIG. 19A is a diagram illustrating a pendulum type rotation detection system for detecting an angle of rotation of a physical object in accordance with one embodiment of the invention.

FIG. 19B is a diagram illustrating the rotation detection system of FIG. 19A when the physical object is rotated about an axis of rotation.

FIG. 20A is a diagram illustrating the use of the rotation detection system of FIG. 19A to determine a coordinate associated with the physical object when the physical object is in a resting state.

FIG. 20B is a diagram illustrating the use of the rotation detection system of FIG. 19A to determine a coordinate associated with the physical object when the physical object is rotated about an axis of rotation.

FIG. 21 is a diagram illustrating one mechanism for determining one or more angles of rotation associated with a physical object using the coordinates previously obtained as shown in FIG. 20A and FIG. 20B when the physical object is rotated about an axis of rotation as shown in FIG. 20B.

FIG. 22 is a process flow diagram illustrating one method of obtaining one or more angles of rotation of a physical object that is rotated about an axis of rotation as shown in FIG. 20B.

FIG. 23A is a diagram illustrating a inverted pendulum type rotation detection system for detecting an angle of rotation of a physical object in accordance with one embodiment of the invention.

FIG. 23B is a diagram illustrating the rotation detection system of FIG. 23A when the physical object is rotated about an axis of rotation in a first direction.

FIG. 23C is a diagram illustrating the rotation detection system of FIG. 23A when the physical object is rotated about the axis of rotation in a second direction.

FIG. 24A is a diagram illustrating a bowl type rotation detection system for detecting an angle of rotation of a physical object in accordance with one embodiment of the invention.

FIG. 24B is a diagram illustrating the rotation detection system of FIG. 24A when the physical object is rotated about an axis of rotation.

FIG. 25A is a diagram illustrating a U-shaped rotation detection system for detecting an angle of rotation of a physical object in accordance with one embodiment of the invention.

FIG. 25B is a diagram illustrating the rotation detection system of FIG. 25A when the physical object is rotated about an axis of rotation.

FIG. 26A is a diagram illustrating a spherical rotation detection system for detecting an angle of rotation of a physical object in accordance with one embodiment of the invention.

FIG. 26B is a diagram illustrating the rotation detection system of FIG. 26A when the physical object is rotated about an axis of rotation.

FIG. 27A is a diagram illustrating a donut shaped rotation detection system used in conjunction with an elongated member in accordance with one embodiment of the invention.

FIG. 27B is a diagram illustrating a donut shaped rotation detection system used in conjunction with a curved elongated member in accordance with another embodiment of the invention.

### DETAILED DESCRIPTION OF TV SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

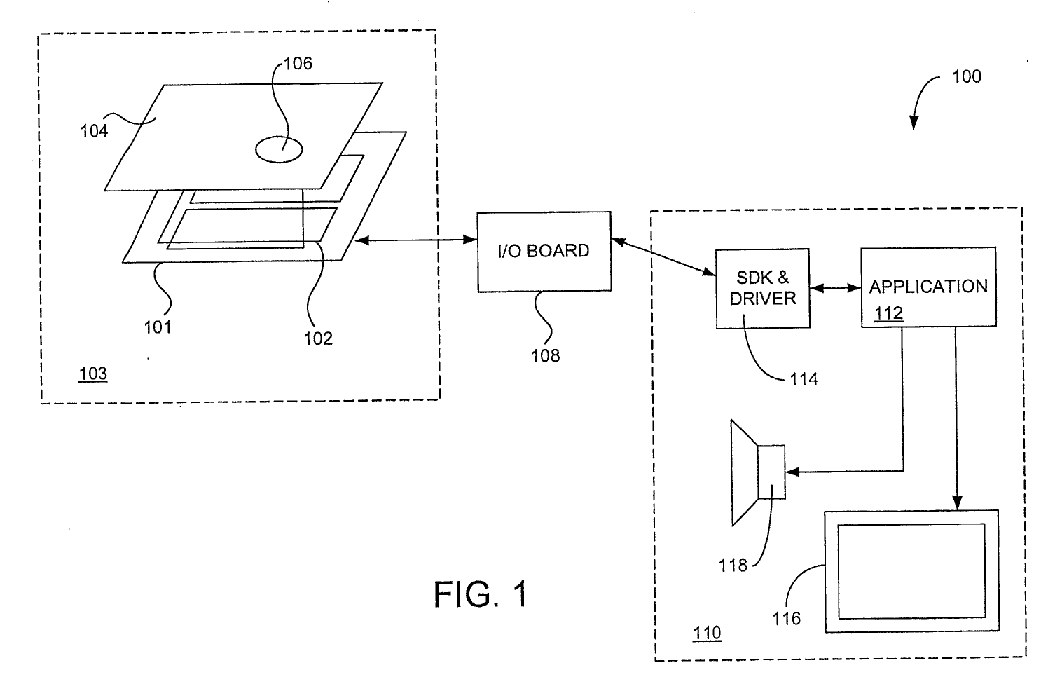

FIG. 1 shows a position detection system 100 in accordance with one embodiment of the present invention. The detection system includes a physical game unit 103, a computer system 110, and an I/O board 108 for interfacing between the physical game unit 103 and computer 110. Although the computer 110 is shown as being a separate component from the physical game unit 103, of course, the computer 110 may be integrated with the physical game unit 103. As shown, the physical game unit 103 includes a board 101 having an antenna 102, a game platform 104, and a physical object 106 having an associated resonator (not shown) and an associated translation mechanism (not shown). The computer 110 includes a software development kit (SDK) and driver 114, application program 112, display 116, and speakers 118.

SDK 114 controls I/O board 108, and data from I/O board 108 is transferred to application program 112. In one embodiment, Macromedia Director® is used to program and translate commands which are interpreted by SDK 114. One skilled in the art will recognize that other commercially available programs could also be used to define and translate commands. Application program 112 written in Macromedia Director makes calls to SDK 114, which makes calls to driver 114, which accesses the I/O board 108. These commands control how an excitation signal is sent by the I/O board 108 to antenna 102.

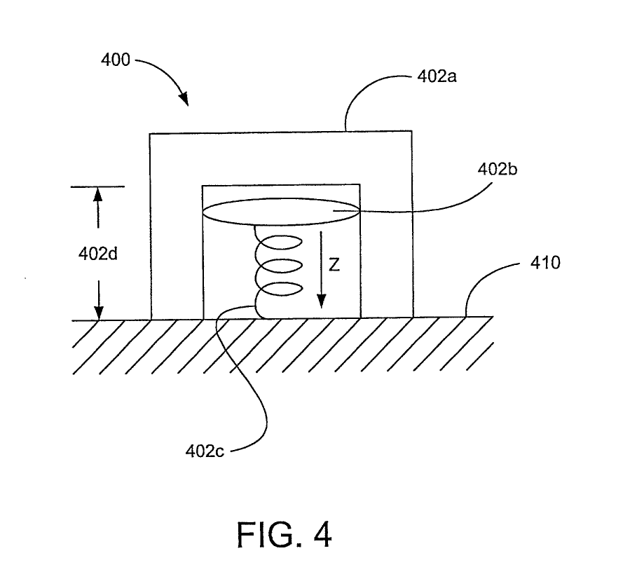

The translation mechanism of the physical object 106 is arranged to translate one or more object state(s) of the physical object into one or more position state(s) of the resonator. In other words, when one of the object states of the physical object is changed, the corresponding position state of the resonator is also changed. Thus, one or more of the resonator position states are related to one or more object states. Several embodiments of translation mechanisms are described further below in reference to FIGS. 4 through 17C.

The resonator of the physical object 106 resonates at a particular resonating frequency, and the excitation signal that is transmitted to the antenna has a particular frequency. Antenna 102 receives a detected signal from the resonator when the resonator “rings” at the particular frequency of the excitation signal. In other words, the detected signal is tied to the resonator's response to the excitation signal.

The detected signal includes positional data regarding the resonator. That is, one or more of the resonator's position state may be ascertained by analyzing the detected signal. Preferably, the positional data includes six degrees of position states: x, y, and z position, and rotational angle.

Any suitable detection mechanism may be implemented to detect position information from each object. In one embodiment, the platform includes an embedded detection mechanism in the form of a looped antenna. A microprocessor within the platform controls signal transmission and reception over the antenna. Each platform may be coupled to a computer, or have an embedded computer system. Application software for the specific structure then controls the microprocessor and detection mechanism. Each of the objects include a resonator. Each resonator is in the form of a coil in series with a capacitor, which resonates at a particular resonating frequency.

During initialization, the application software sends a list of frequency values to the microprocessor within the platform. The frequencies correspond to individual objects. That is, the frequency values correspond to individual resonating frequencies of the objects that may be placed on the platform. The microprocessor uses the frequency values to detect the positions of each object. The microprocessor selects a first frequency value that corresponds to a specific object. The microprocessor then generates an excitation signal at the first frequency on the antenna. The transmitted excitation signal is in the form of an AC current at the first frequency that causes an AC field over the antenna.

If present, the resonator of the corresponding object resonates in response to the AC field of the excitation signal and generates its own AC field. The AC field of the resonator couples with the antenna to induce a resonator signal on the antenna. The microprocessor turns off the excitation signal so that the resonator signal may be detected on the antenna without interference by the excitation signal. That is, when the antenna's excitation signal is stopped, the activated resonator continues to produce a “ringing” signal that continues to be induced on the antenna and, thus, is clearly detected on the antenna without interference by the excitation signal. The amplitude of the resonator signal depends on the object's position relative to the AC field of the excitation signal. In effect, the resonator of the object reflects the excitation signal back onto the antenna in the form of the resonator signal.

The resonator signal is sent to the computer where it is then analyzed to determine the selected object's position. The first frequency value is also sent back to the computer so that the application software may match the frequency value to an identity of the object. The application program generates an audiovisual program based on the detected position signals and corresponding object identities. The relationship between each object and its corresponding resonator frequency is known (e.g., by the application software). In other words, the identity of each object as it corresponds to a resonator frequency is known.

The detected signal is sent through the I/O board 108 to the driver 114, passes through SDK 114 and to application program 112. Positional data is determined based on the detected signal, and the positional data is processed and used to generate an audiovisual program that is based on the positional data. Examples of methods for generating audiovisual programs based on positional data are described further in U.S. patent application Ser. No. 09/018,023 filed Feb. 2, 1998 entitled “Computer Method and Apparatus for Interacting with a Physical System” by Piernot, et al.

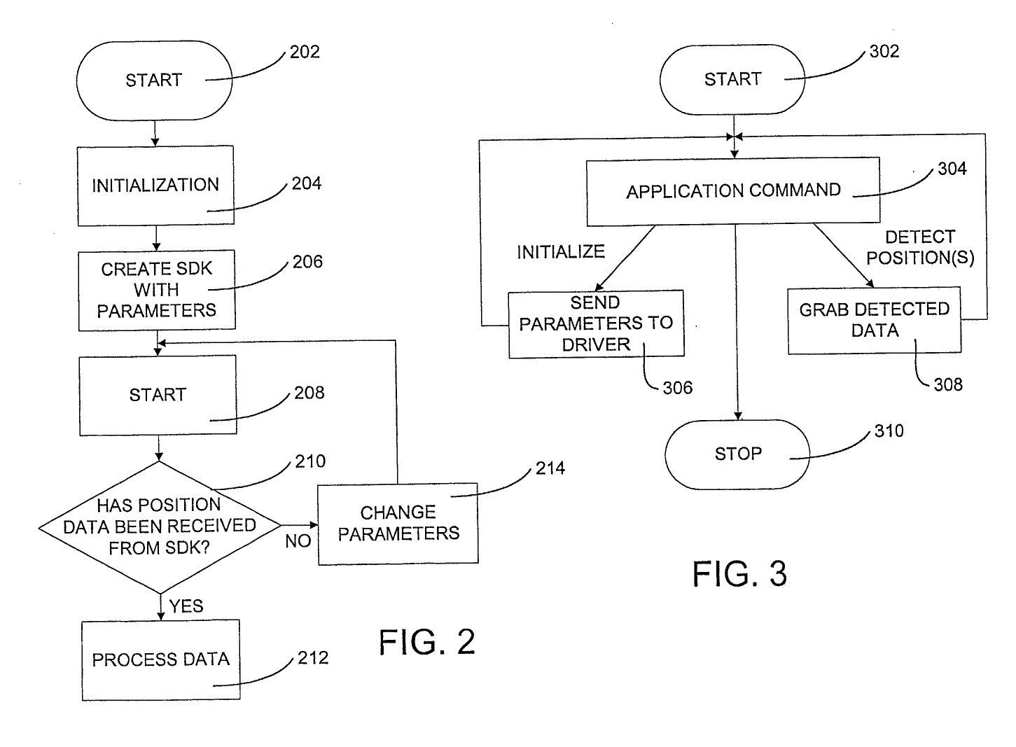

FIG. 2 conceptually illustrates the software operating in Macromedia Director portion of application program 300 in accordance with one embodiment of the present invention. The process begins at 202 and in a operation 204, Macromedia Director is initialized. SDK 114 is initialized with parameters in operation 206. The parameters may include frequency of the excitation signal, as well as interpretation criteria for the detected signal. Operation 208 starts the SDK 114. Once the SDK is started, operation 210 checks whether positional data has been received. If no positional data has been received, then new SDK parameters may be generated in operation 214. If positional data has been received from SDK 114, then the positional data is processed in operation 212.

FIG. 3 illustrates the operation of SDK 114 in accordance with one embodiment of the present invention. The process begins at operation 302. In operation 304, an application command is received. If the command is to initialize, control is transferred to operation 306 and parameters are sent to the driver. In one embodiment, the driver is used with Data Acquisition Card from National Instruments. It will be apparent to one of ordinary skill in the art that other drivers can be used as well. If the application command is to start detecting, control is transferred to operation 308 which starts and controls the detection function. Once the detection function is complete, control is again transferred back to operation 304, and the cycle continues until a stop command is received and the process is terminated at 310.

As described above, the present invention includes a translation mechanism that converts an object state of the physical object to a resonator position state of an associated resonator. Techniques for detecting a position of a resonator on the game platform 104 are initiated by the computer system 110. The detected position data from the resonator may then be used to determine various object states, such as position of the physical object that are associated with the resonator. The detected position data may also be used to determine other object states of the physical object, such as weight, identity, and shape orientation. In other words, the detected position data may be utilized to determine an object state other than position. Several mechanisms for translating an object state into resonator position state and methods for determining the object state are described below in reference to FIGS. 4 through 17C.

Several other coil arrangements for detecting or determining an object's x, y, and z position through electromagnetic induction are described in PCT No. WO9858237(A1) (Application No. PCT/GB98/01759), which application is herein incorporated by reference. This PCT application also describes mechanisms for determining an object's tilt (relative to a vertical axis) and orientation (rotation within the x-y plane). Mechanisms for determining an object's linear position (e.g., x or y position) are described in U.S. Pat. No. 5,815,091, which is also incorporated by reference. The detection mechanisms described in these PCT and U.S. applications may also be utilized with the translation mechanisms presented herein to determine various object states.

In one embodiment, the game platform (e.g., 104 of FIG. 1) is interchangeable, and the same antenna may be used with multiple boards. Additionally, each platform may be identified by a position of an embedded resonator with respect to the platform. A particular resonator is associated with platform identification, and each platform includes this resonator. That is, the particular resonator has a predetermined frequency range that is only used to identify platform type. The particular resonator is positioned at different locations within or upon each different board platform such that the platform type may be determined by detecting a position of the resonator of the platform. Thus, resonator position is translated into a platform identification.

In another embodiment, the resonator and physical object may be positioned such that a change in one degree of freedom for the physical object results in a change in another degree of freedom for the resonator. For example, changing a z position of the physical object results in a corresponding x position change of the associated resonator. By way of another example, changing the rotation of the physical object results in a y position change of the associated resonator. By way of another example, changing a shape of the physical object results in an x position change of the associated resonator.

FIG. 4 is a diagrammatic side view of a physical object 402a and associated resonator 402b that may be used to determine an identity of the physical object 402a in accordance with one embodiment of the present invention. The resonator may be arranged in any suitable configuration such that when a physical object having a particular shape is placed over or adjacent to the associated resonator, the resonator moves in a particular way that depends on the shape of the physical object. For example, the shape of the physical object causes the associated resonator to move to a predetermined z position. This predetermined z position may then be detected and used to determine the physical object's identity. In other words, the physical object may be identified by its shape.

As shown, the associated resonator is mounted on a spring 402c that is affixed to the game platform 410. In this embodiment, different physical objects have different sized cavities (e.g., 402d) that are configured to compress the spring by a predetermined z distance) when the physical object is placed on top of the resonator. If the cavity sizes of the physical objects are known, the identity of the physical object (e.g., 402a) that is positioned over the resonator 402d may be determined by measuring the position of the resonator 402b and detecting how far the spring 402c has moved in the z direction. The detected z position may then be matched with a known cavity size and physical object identity.

The present invention allows efficient use of a limited number of resonators. That is, one resonator frequency may be used to identify several different physical objects. The physical object has a shape that causes the associated resonator to move by a predetermined amount which amount corresponds to the physical object's identity. In other words, the physical object's shape is utilized to identify the physical object, as compared to conventional detection systems that utilize different resonators to identify different physical objects.

Alternatively, more than one resonator may be used to identify one physical object. When a physical object having a particular shape is engaged with the resonators, some of the resonators move a predetermined amount. The movement or non-movement may form a code (e.g., a binary code) that identifies the particular physical object. This configuration provides for a higher number of identities than the single resonator configuration (e.g., FIG. 4), while still using a relatively small number of resonators. Preferably, the degree of movement may form a nonbinary code that identifies the particular object. This configuration allows a higher number of identities than the binary code with the same number of resonators.

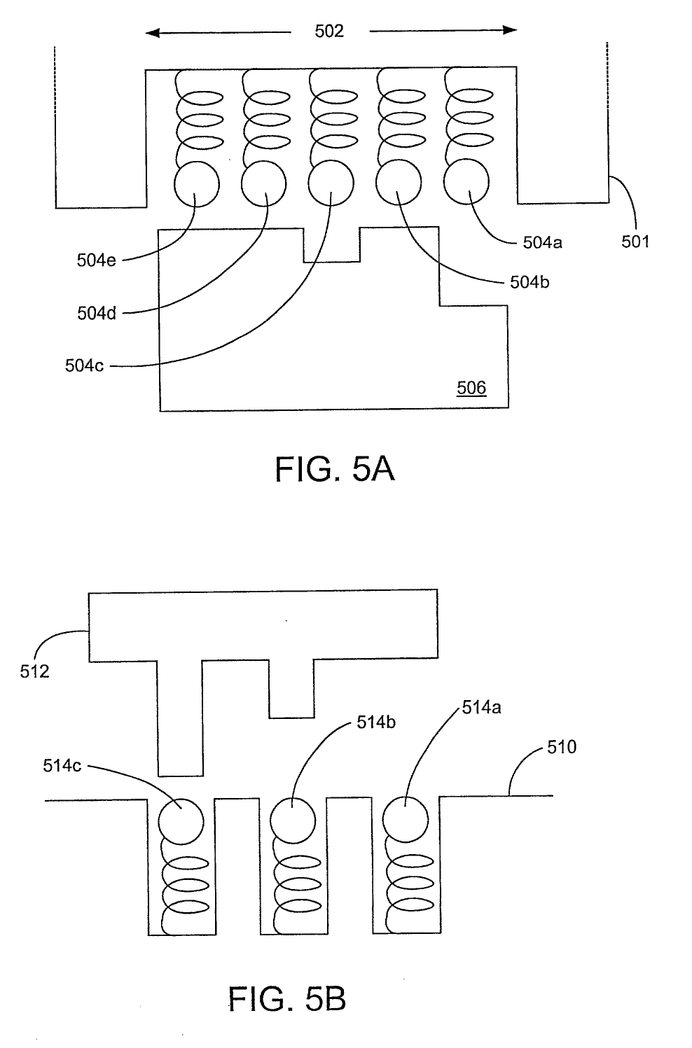

FIG. 5A is a diagrammatic top view of a physical object 506 and a plurality of resonators 504 that may be used to determine a coded identity of the physical object 506 in accordance with one embodiment of the present invention. As shown, a plurality of resonators 504 are mounted on associated springs that are attached within a slot 502. The slot 502 is configured to receive a physical object (e.g., 506). When a particular physical object (e.g., 506) is inserted into the slot 502, one or more of the resonators move depending on a shape of the particular physical object. For example, when the physical object 506 is inserted, resonators 504a remains at the same position, while resonators 504b through 504e are moved by the physical object. Additionally, the resonator 504c is moved for a smaller distance than the resonators 504b, 504d, and 504e. The relative positions of the resonators may then be used to determine the identity of the physical object 506.

Alternatively, FIG. 5B is a diagrammatic side view of a pegboard type configuration for detecting identity in accordance with one embodiment of the present invention. As shown, a physical object 512 is configured to have peg legs with varying lengths that fit into peg holes of a game platform 510. A resonator 514 is coupled with a spring that is positioned within each peg hole. The varying leg lengths cause some of the associated resonators to move a predetermined distance when the physical object is inserted into the peg holes. The relative movement of the resonators may then be detected and used to determine the identity of the physical object.

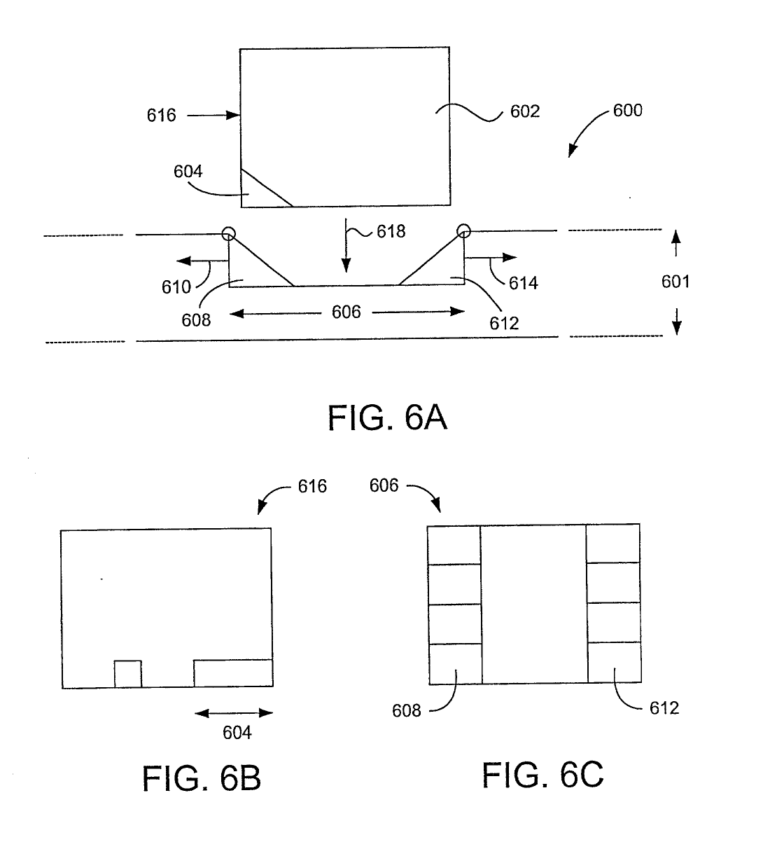

Although the present invention has been described as implementing resonators that move in a same direction as the physical object (e.g., the physical object is inserted horizontally into a slot, and resonator(s) move horizontally), of course, the resonators may also be configured to move in a different direction from the physical object. In other words, any mechanism for biasing the resonators against a physical object may be implemented. For example, FIG. 6A is a diagrammatic side view of a door bolt type configuration 600 for detecting an identity of a physical object 602 in accordance with one embodiment of the present invention.

As shown, the door bolt configuration 600 includes a game platform 601 having a slot 606 for receiving a physical object (e.g., 602). The slot 606 includes one or more door bolts (e.g., 608 and 612) that are configured as part of a cam shaft, rotary, and/or spring loaded mechanism such that when a physical object is inserted into the slot, some of the door bolts are pushed in a horizontal direction (e.g., direction 610 or 614). As shown, when physical object 602 having a cutaway portion 604 is inserted into slot 606, the door bolt 612 is pushed aside in direction 614, while door bolt 608 remains in place. FIG. 6B is a diagrammatic side view of side 616 and cutaway portion 604 of the physical object 602 of FIG. 6A. FIG. 6C is a top view of the slot 606 of FIG. 6A. As shown, a plurality of door bolts (e.g., 608 and 612) line two sides of the slot 606. However, the slot may include any number and configuration of door bolts.

In another embodiment, a resonator is configured to provide positional data for more than one physical object. In other words, a first degree of freedom (e.g., rotation) of the resonator is used to determined a corresponding rotation of a first physical object, and a second and a third degree of freedom (e.g., x and y position) of the resonator are used to determine a corresponding x and y positions of a second object. The basic idea is to form a first link between the desired degrees of freedom of the first physical object and associated degrees of freedom of the resonator and a second similar link between the second physical object and other degrees of freedom of the same resonator. Most importantly, the first link should be configured to not interfere with the second link.

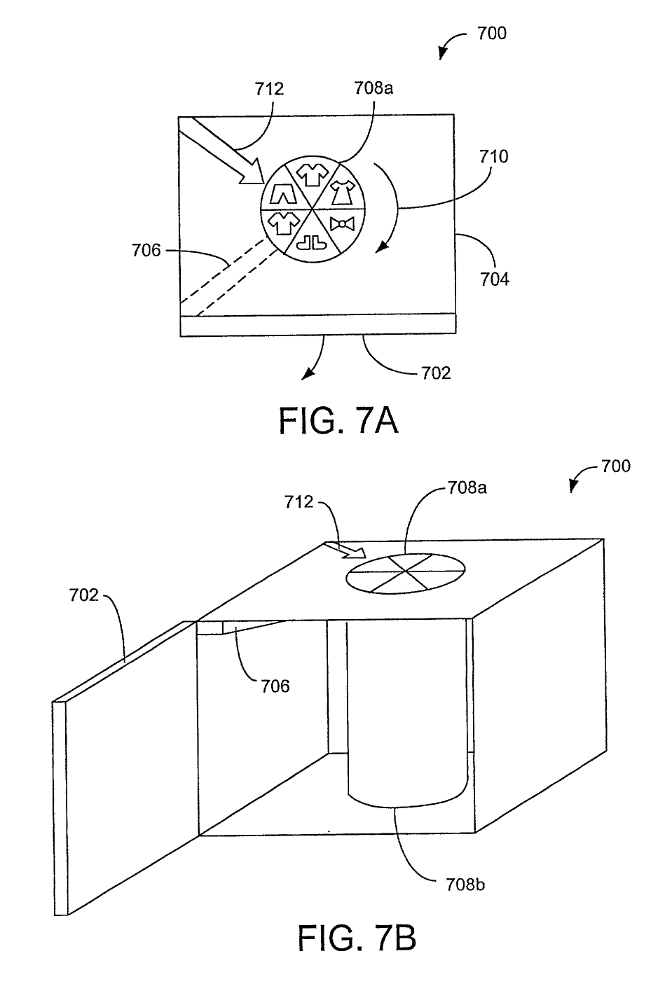

FIG. 7A is a top view of a toy closet 700, and FIG. 7B is a side view perspective of the closet 700 in accordance with one embodiment of the present invention. The toy closet 700 includes a door 702 that may be opened or closed by the user. The toy closet also includes a knob 708a that is rotatably configured such that the user may turn it. For example, the user may choose clothing by positioning the knob 708 relative to an indicator 712.

A resonator 708b is coupled with the knob, for example, at the bottom of the closet 700 (see FIG. 7B). When the user turns the knob in direction 710, the resonator is correspondingly rotated. The resonator 708b is also coupled with the door 702 through arm 706. When the user opens and closes the door 702, the arm 706 and, as a result, the resonator moves in the x and y directions. Thus, two different states of the closet 700 may be determined by obtaining different positional data from the resonator 708b. That is, it may be determined whether the door is open or closed (or how much the door is opened) by detecting an x and y position of the resonator 708b. The rotation of the knob 708a with respect to the indicator 712 may be determined by detecting the rotation of the resonator 708b.

In yet another embodiment, a physical object's position is fixed with respect to a first one of the degrees of freedom. The physical object includes a movable object that is movable within this first degree of freedom. The movable object is associated with a resonator and may be used to identify the physical object, as well as determine a position or state of the movable object of the physical object. In other words, the resonator's particular frequency may identify the physical object, and/or a change in the resonator's position corresponds to a change in position or state of the movable object. To name a couple of examples, the physical object may include a movable lever and/or a rotatable wheel or knob.

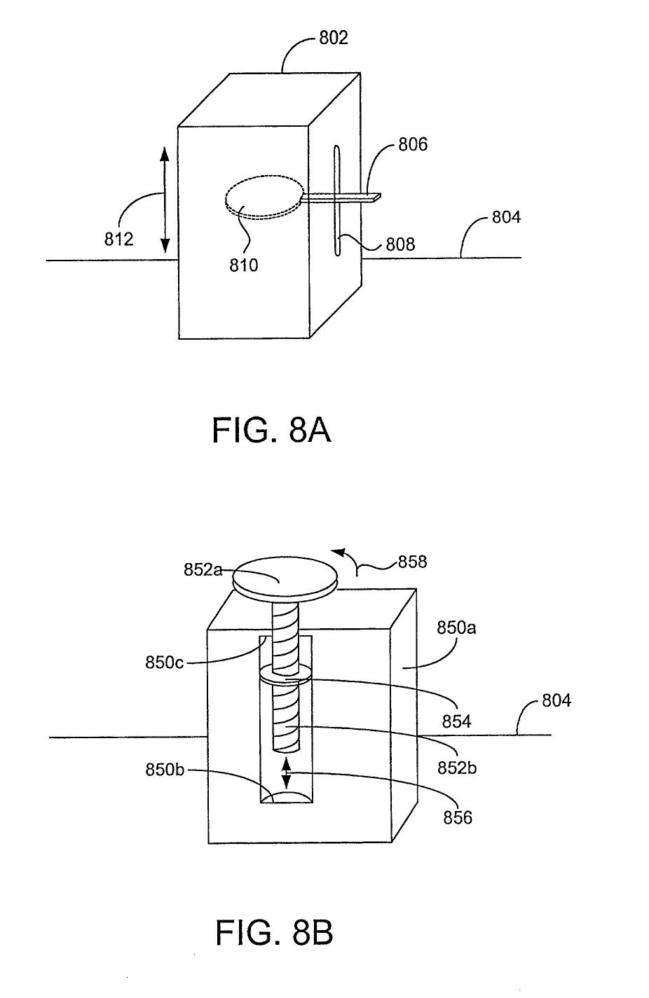

FIG. 8A is a diagrammatic perspective view of a physical object 802 having a lever 806 in accordance with one embodiment of the present invention. As shown, the lever 806 is configured such that it may be moved up or down along direction 812 within slot 808. The lever 806 is coupled with a resonator 810 that also moves up and down with the lever 806. In other words, the lever 806 and resonator 810 are configured such that movement of the lever 806 results in a corresponding resonator 810 movement. Thus, the state of the physical object's lever (e.g., up or down) may be determined by detecting a z position of the resonator 810 and translating the detected z position into an associated lever state (e.g., up, down, or somewhere in between). Note, the physical object should remain stationary with respect to the z axis so that the state of the lever 806 may be accurately determined. However, the physical object may be movable within other dimensions, such as the x and y directions, and the resonator may also be used to determine the other positions (e.g., x and y) of the physical object. Additionally, a frequency of the resonator 810 may be used to identify the physical object 802.

FIG. 8B is a diagrammatic perspective view of a physical object 850 having a rotatable knob or screw 852 in accordance with one embodiment of the present invention. As shown, the physical object 850 forms a cavity 850b for accepting the screw 852. The physical object 850 is configured to engage the screw 852 at screw hole 850c such that the screw may be screwed up and down within the cavity 850b. The screw 852 is also coupled with an associated resonator 854 such that when the screw moves up and down the resonator 854 also moves up and down. For example, the resonator 854 has a hole for receiving the screw, and the resonator 854 is sized such that it slides along the cavity walls. Note, the physical object should remain stationary with respect to rotation so that the state of the screw 825 may be accurately determined. However, the physical object may be movable within other dimensions, such as the x and y directions, and the resonator may also be used to determine the other positions (e.g., x and y) of the physical object. Additionally, a frequency of the resonator 854 may be used to identify the physical object 850.

In yet another embodiment, a physical object having a known configuration and two or more associated resonators are configured such that an orientation of the known configuration of the physical object may be determined based on the resonators' positions. For example, two or more resonators are placed within an physical object such that a topology and/or orientation of such topology of the physical object may be ascertained from the resonators' positions.

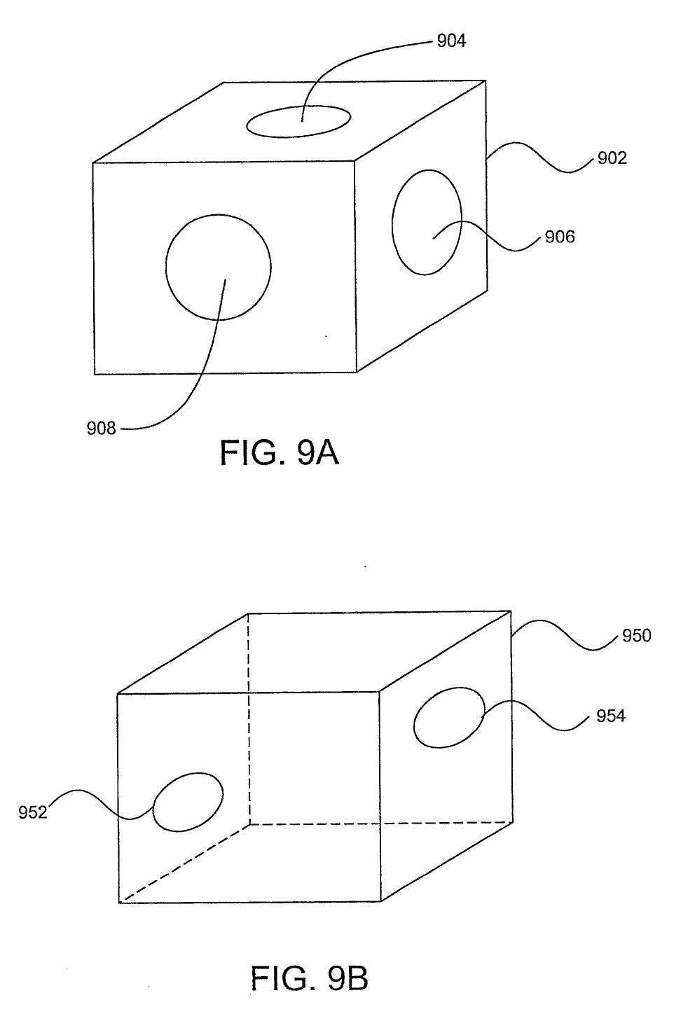

FIG. 9A is a perspective view of a six-sided die 902 having three associated resonators (904, 906, and 908) for determining die position in accordance with one embodiment of the present invention. In this embodiment, each resonator 904, 906, and 908 has a different frequency range. By determining which resonator is at a maximum or minimum z position, the die's orientation may then be determined. The following Table 1 summarizes the die's six possible positions and corresponding resonator positions:

TABLE 1

| Resonator Ref No. | Z Position | Die Position |
|---|---|---|
| 904 | Min | 1 |
| 904 | Max | 4 |
| 906 | Min | 2 |
| 906 | Max | 5 |
| 908 | Min | 3 |
| 908 | Max | 6 |

FIG. 9B is a perspective view of a six-sided die 950 having two associated resonators 952 and 954 for determining die position in accordance with one embodiment of the present invention. As shown, the two resonators 952 and 954 are positioned on opposite sides of the die 950. Each resonator has a different x, y, and z positioned such that the six different positions of the die 950 may be distinguished by detecting the x, y, and z positions of the resonators 952 and 954.

Although the present invention has been described with a physical object in the form of a die, of course, the present invention may also be implemented with any three-dimensional object having any shape and/or configuration. That is, it should be well understood that three resonators that output x, y, and z position information may be used to determine an orientation (e.g., all positions of all points) of a three-dimensional object. Additionally, two resonators that output four degrees of freedom (e.g., x, y, z, rotation and/or tilt information) may be used such that the object's orientation may be determined by detecting the positions of the two resonators. In an alternative embodiment, one resonator may be used to determine the orientation of a three-dimensional object when the resonator outputs x, y, z, rotation, and tilt information.

In summary, many mechanisms for determining various physical object states are described above. These mechanisms allow a reduction in the number of resonators that are necessary for determining the physical object's identification (e.g., as illustrated in FIGS. 4, 5, and 6), movable object state (e.g., as illustrated in FIGS. 8A and 8B), and/or orientation (e.g., as illustrated in FIGS. 9A and 9B). Additionally, each resonator may be configured to allow determination of the states of more than one physical object, as illustrated in FIGS. 7A and 7B.

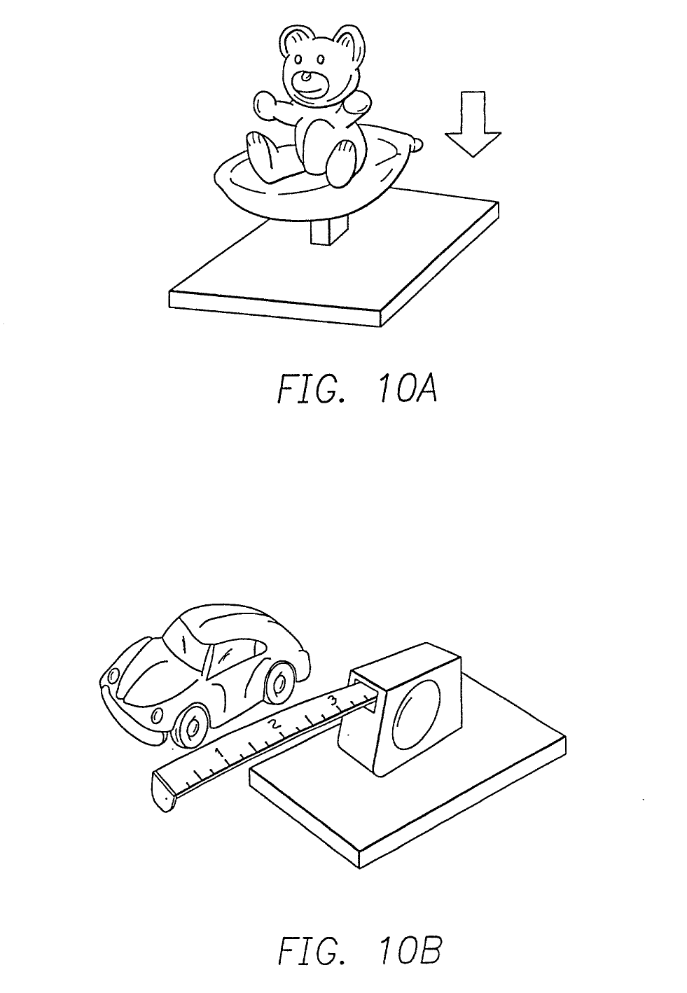

Further examples of mechanisms for translating various physical object states into one or more resonator positions are illustrated in FIGS. 10A through 17C. Although many different mechanisms may be used to implement the present invention, only a few exemplary mechanisms are described below in reference to FIGS. 10A through 17C and are not meant to limit the scope of the invention.

As illustrated in FIG. 10A, one or more resonators may be configured to detect a weight of a physical object 1002 (as shown, a teddy bear). The physical object 1002 is placed on a scale 1004, which placement causes one or more resonators to correspondingly move in direction 1006, for example. In other words, the weight of the physical object results in a corresponding change in the associated resonator's position. The resonator position may then be detected and translated into a weight of the physical object. For example, a look-up table may include a plurality of weights and associated resonator positions, or a formula may be implemented to convert the resonator position into a weight value (e.g., F=−kx).

Similarly, FIG. 10B shows another measuring device 1010 (as shown, a tape measurer) that is used to measure a physical object 1008 (as shown, a car). As the physical object 1008 is measured (e.g., as the tape is pulled out), one or more associated resonators (not shown) move in a vertical direction, for example. Thus, the position of the resonator(s) may then be detected and translated into a measurement value for the physical object 1008.

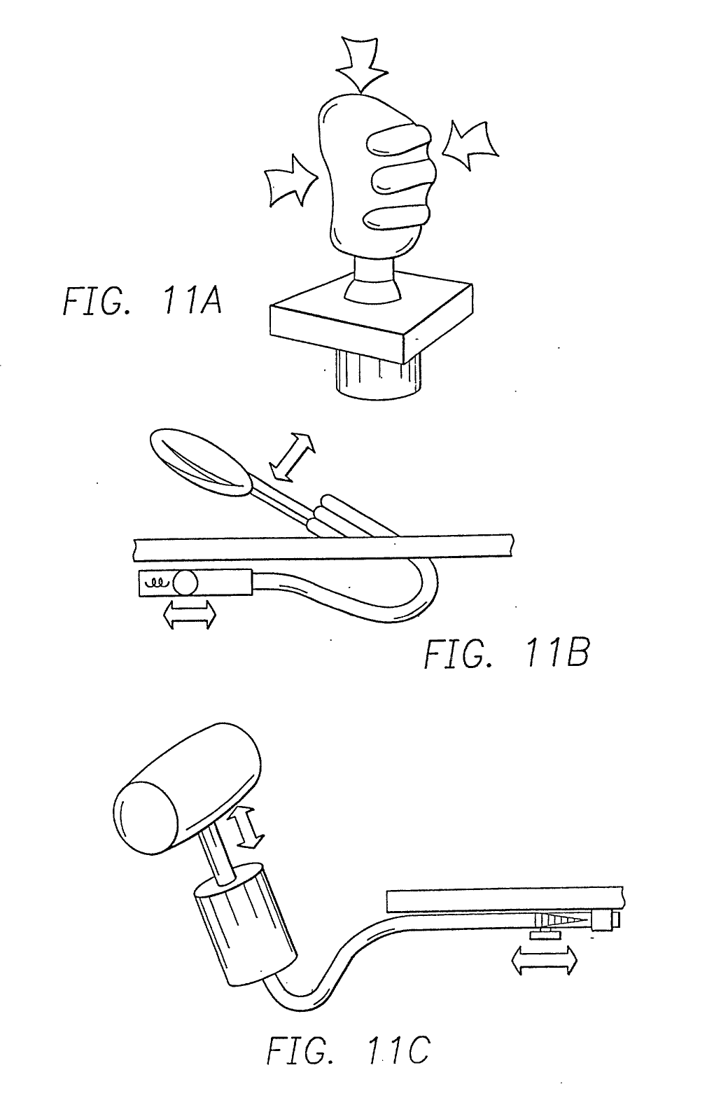

FIGS. 11A through 11C represent various air pumping mechanisms. For example, FIG. 11A shows a “pop-squeeze” type mechanism, wherein the user squeezes and moves a handle 1102. The handle 1102 is coupled with a diaphragm 1104 having a resonator that moves in a z direction 1106 with inflation or deflation of the diaphragm. Movement of the handle 1102 causes the diaphragm to inflate and the resonator to move. Thus, the handle movement may be tracked by detecting the movement of the resonator. Likewise, FIG. 11B shows a lever pumping mechanism, wherein pumping of a lever 1108 causes an associated resonator 1110 to move in an x direction 1112 within an air-filled tube 1114 that is connected to the lever 1108. FIG. 11C is another air-pump mechanism, wherein pumping of a handle 1116 in a z direction 1118 results in resonator movement 1122 within an air tube 1120. In sum, a pumping amount may be determined by tracking associated resonator positions.

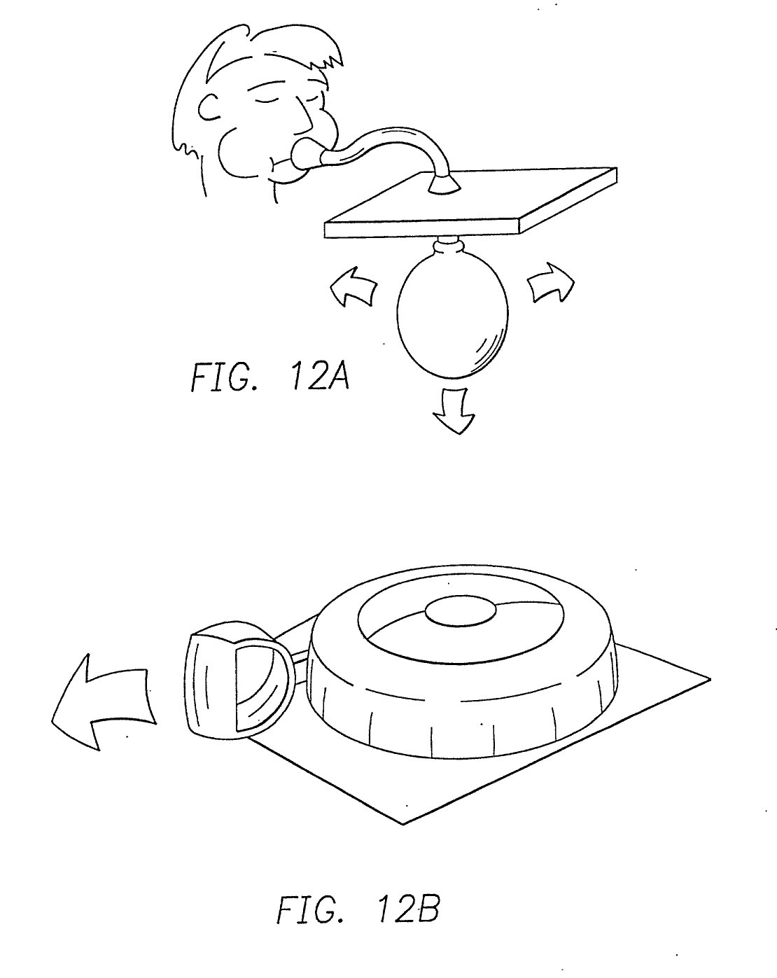

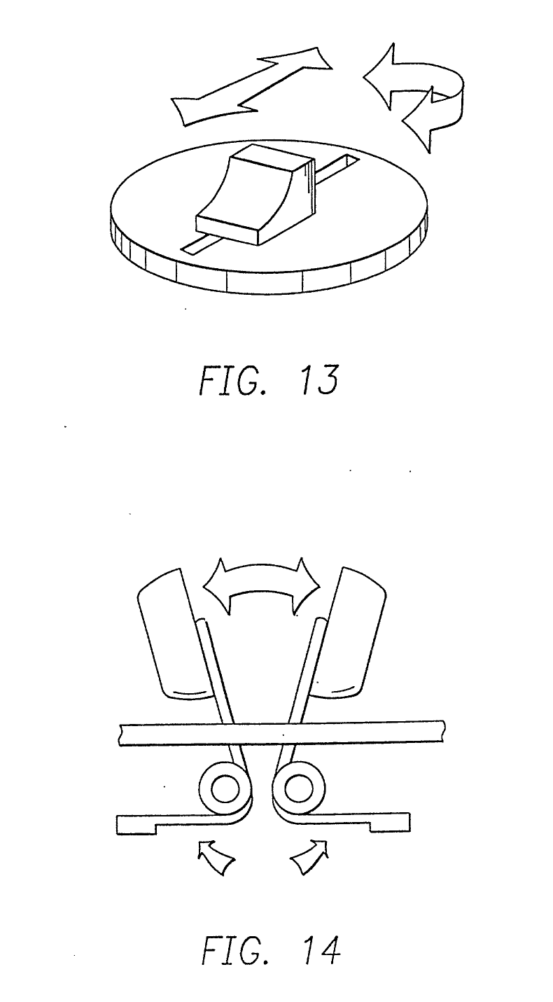

FIG. 12A represents a balloon mechanism, wherein a resonator (not shown) is located on a balloon 1202. When the balloon 1202 is inflated, the resonator position is altered and then detected, and the balloon radius or inflation amount may then be determined. FIG. 12B shows a pull-cord device 1204, wherein the cord 1206 is wrapped around a resonator (not shown) such that pulling the cord 1206 results in rotation of the resonator. Thus, the cord state (e.g., pulled out or retracted) may be determined by tracking the resonator position.

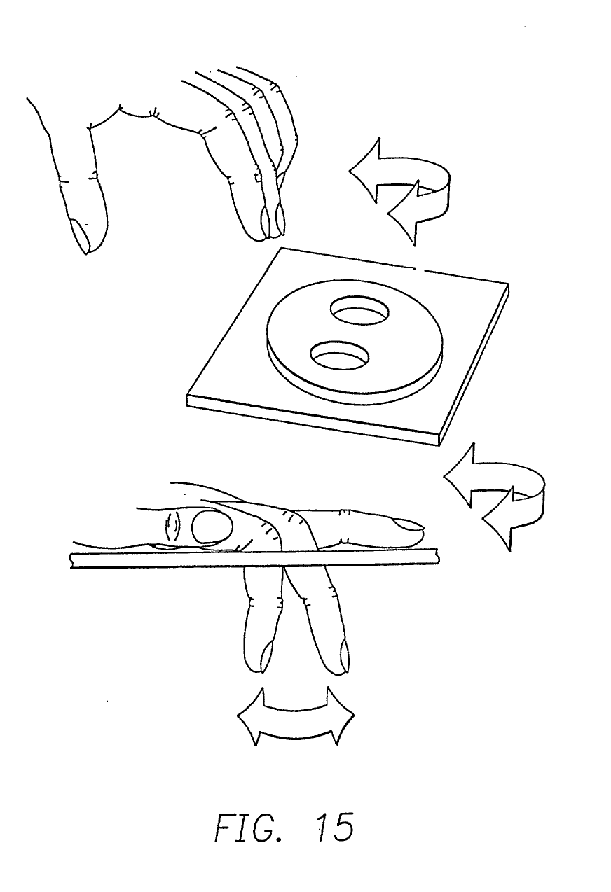

FIG. 13 represents a physical object 1302 having a slider 1304 and is configured to be rotatable. In one embodiment, a resonator may be coupled to the slider 1304 such that the slider's state 1308 (e.g., slider position) may be detected as well as the physical object's rotation state 1306 by detecting a rotation and x and y positions of the resonator.

FIG. 14 illustrates a pair of levers 1400 that may be moved together and apart in direction 1402. An associated resonator (e.g., 1404a and 1404b) is coupled to each lever 1400 such that a state of the levers (e.g., apart or together) may be determined by detecting the x positions of each resonator. FIG. 15 shows a “finger-walking” mechanism for detecting a walking motion of a user's fingers. A resonator is placed below the user's fingers, and when the user makes a walking motion, the resonator moves (e.g., rotates). Thus, the user's finger-walking movement may be tracked in time, for example, by detecting a rotation position of the resonator over a predetermined time period.

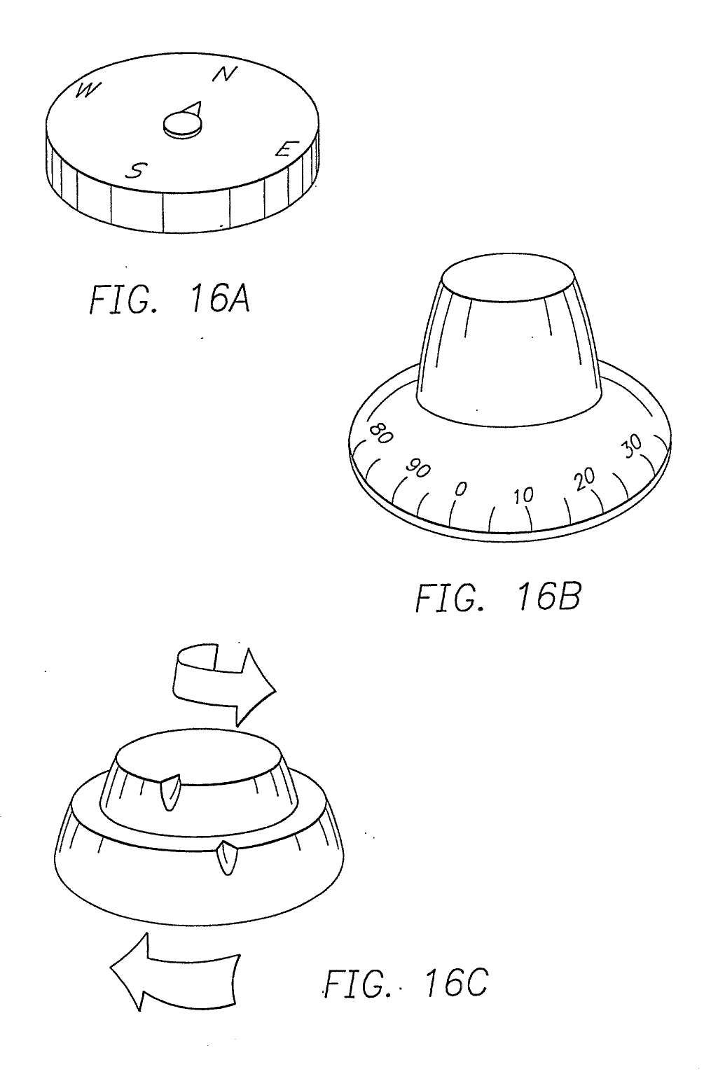

FIGS. 16A through 16C represent various rotary mechanisms for detecting a state of various types of physical objects. For example, FIG. 16A shows a compass device that is coupled with a resonator such that a compass direction may be determined by detecting the resonator's rotation. Likewise, FIG. 16B illustrates a combination type lock that is also coupled with a resonator. The resonator and lock are configured such that the turnings of the lock may be tracked by tracking the resonator's rotational positions. FIG. 16C illustrates a “dial-within-a-dial” mechanism having two concentric knobs 1602a and 1602b that are independently rotatable (e.g., 1604a and 1604b). Each knob is coupled with an associated resonator such that the knobs relative positions may be determined by detecting relative resonator rotation positions.

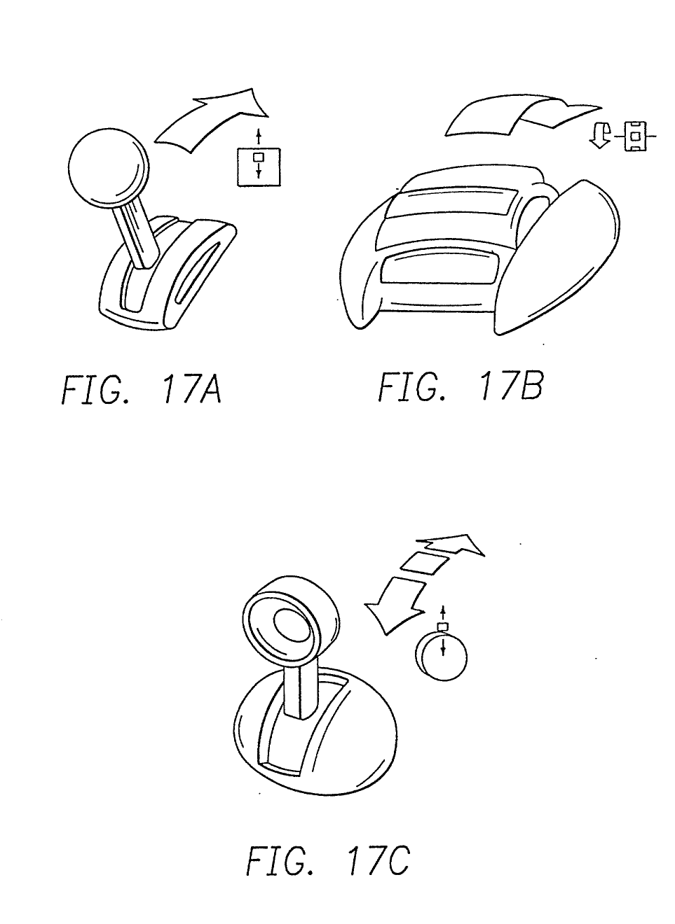

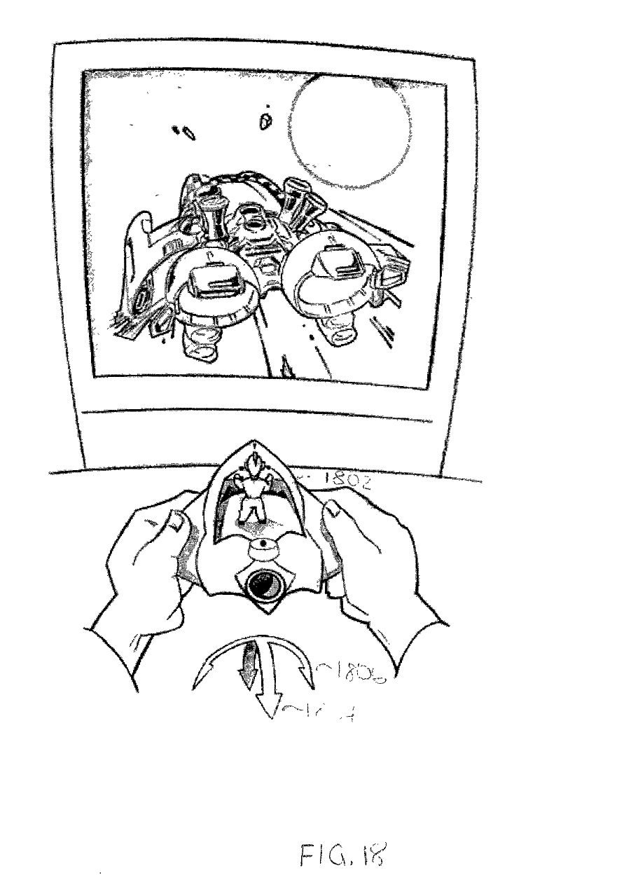

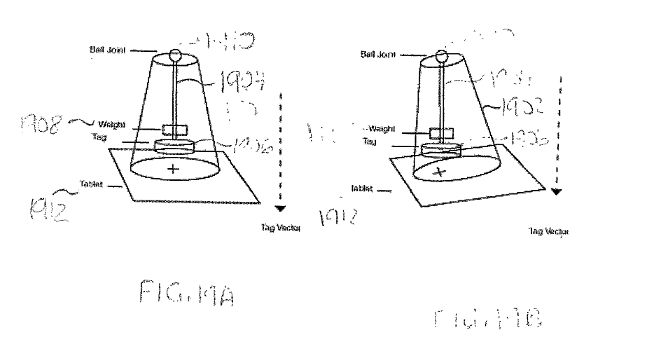

FIG. 17A through 17C represent various handle type mechanisms, wherein the handle's position results in an associated resonator position change. FIG. 17A shows a shift type handle 1802 that rotates around a central axis. The shift type handle 1802 is coupled with a resonator that preferably moves in one direction 1806 (e.g., along the z axis) in response to handle movement 1804. FIG. 17B shows a “barrel” type control wheel 1808 that rotates around a central axis 1810. The barrel control wheel 1808 is also linked to a resonator that correspondingly rotates in a direction 1812 in response to the barrel wheel rotational movement 1810. FIG. 17C illustrates a vertical jog shuttle, wherein when a handle 1814 is moved along a rotational path 1816, a resonator moves along a rotational path 1818. In the examples of FIGS. 17A through 17C, the handle's states may be determined by detecting a position of the associated resonator.

In addition to the mechanisms described above, it may be desirable to detect the orientation of a physical object (e.g., an angle of rotation of the physical object) which may be used as an alternative to or in combination with one or more of the above-described mechanisms. For instance, it may be desirable to detect an angle of rotation of a physical object that is identified using a pegboard type mechanism. However, it may also be desirable to detect an angle of rotation of a physical object that is held manually by a user.

FIG. 18 is a diagram illustrating the use of a mechanism for detecting an angle of rotation in accordance with one embodiment of the present invention. As shown, a physical object 1802 such as a space ship may be manipulated manually such that it is rotated about an axis. As one example, the space ship may be rotated 1804 about a first axis of rotation to create a motion commonly referred to as “roll”. As another example, the space ship may be rotated 1806 about a second axis of rotation to create a motion commonly referred to as “pitch”. Through the use of the present invention, the amount of rotation of the physical object is detected and depicted in an image of the physical object as shown in a display 1808.

As will be described with reference to the following figures, a rotation detection system for detecting an angle of rotation of a physical object is disclosed. A physical object such as the spaceship shown in FIG. 18 may be rotated such that one or more angles of rotation of the physical object are detected. This is accomplished, in part, through the use of a rotation detection object movably coupled to the physical object, where the rotation detection object is moveable among two or more positions (e.g., in relation to the physical object or another rotation detection object) in response to gravitational pull. In addition, a position detection mechanism is adapted for detecting a coordinate of the rotation detection object. When a coordinate of the rotation detection object is detected, a rotation detection mechanism translates the coordinate of the rotation detection object to one or more angles of rotation of the physical object.

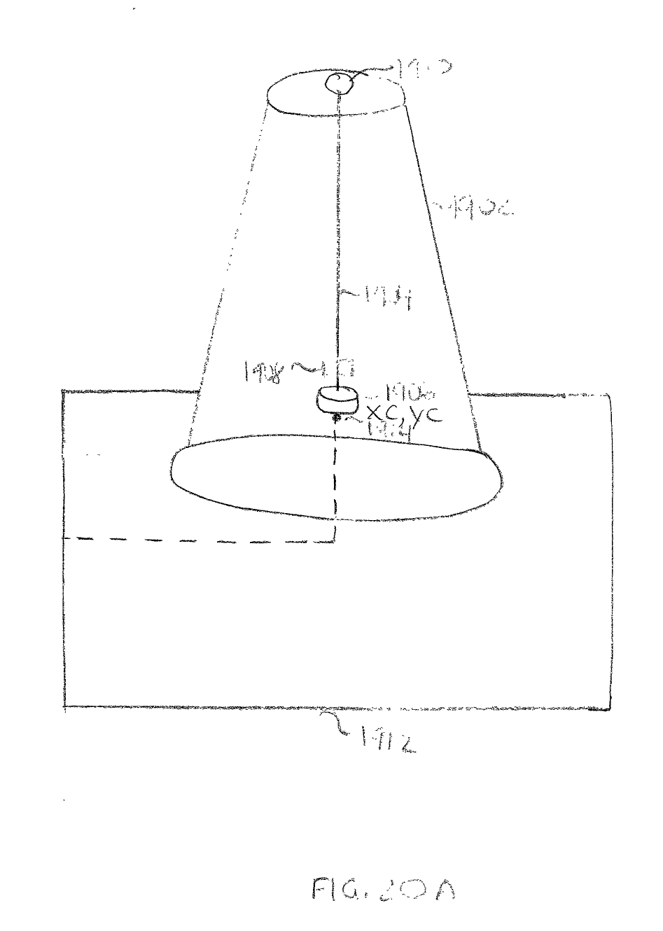

According to one embodiment, the rotation detection object is a pendulum. FIG. 19A is a diagram illustrating a pendulum type rotation detection system for detecting an angle of rotation of a physical object in accordance with one embodiment of the invention. As shown, in this embodiment, a rotation detection system for detecting an angle of rotation of a physical object includes a physical object 1902 (e.g., housing, spaceship, etc.). The physical object 1902 includes a rotation detection object 1904. The rotation detection object 1904 is moveable among two or more positions in response to gravitational pull. More particularly, in this embodiment, the rotation detection object 1904 is moveable among a plurality of positions in response to gravitational pull. As shown, the rotation detection object 1904 includes a first end and a second end, the first end being rotatably coupled to the physical object 1902. The second end is free to rotate or swing in relation to the coupled first end. In addition, a weight 1908 may be used on a suitable location of the rotation detection object 1904 to create a functioning pendulum. As shown, the rotation detection object 1904 is rotatably coupled to the physical object 1902 through ball joint 1910.

As described above, positions of objects may be detected through the use of a resonator. Thus, according to one embodiment, the rotation detection object 1904 includes a resonator 1906 that may be affixed, for example, to a tag or puck at the second end of the rotation detection object 1904, as shown. The resonator 1906 is arranged to output a resonator signal when an excitation signal with a predetermined frequency range is received by the resonator. A platform 1912 (i.e., tablet) may be coupled (e.g., affixed) to the physical object 1902 as shown, and therefore is rotatably coupled to the rotation detection object 1904. In one embodiment, both the platform 1912 and the rotation detection object are incorporated within a suitable physical object, such as a toy space ship or airplane.

The platform 1912 may include a transmitter or antenna that is arranged to output an excitation signal to the resonator 1906. When the transmitter of the platform 1912 outputs the excitation signal, the resonator resonates and transmits a resonator signal. A position detection mechanism then detects a coordinate of the resonator (e.g., in relation to the platform 1912). For instance, the resonator signal may be received by a receiver in the platform 1912. Alternatively, the antenna may be utilized to output the excitation signal, as well as receive the resonator signal from the responding resonator. The position detection mechanism may then translate this resonator signal to a coordinate of the rotation detection object 1904 in relation to the platform 1912. More particularly, the coordinate of the rotation detection object 1904 may be determined when the rotation detection object 1904 is in a resting state (i.e., when the physical object is not being rotated).

Once the physical object is rotated (e.g., tilted), a new coordinate of the rotation detection object 1904 may be determined. FIG. 19B is a diagram illustrating the rotation detection system of FIG. 19A when the physical object is rotated about an axis of rotation. Once the new coordinate of the resonator 1906 is determined, a rotation detection mechanism translates the new coordinate of the resonator 1906 to one or more angles of rotation of the physical object 1902. In other words, the rotation detection mechanism translates the change in coordinates from the old coordinate to the new coordinate of the resonator 1906 to one or more angles of rotation of the physical object 1902.

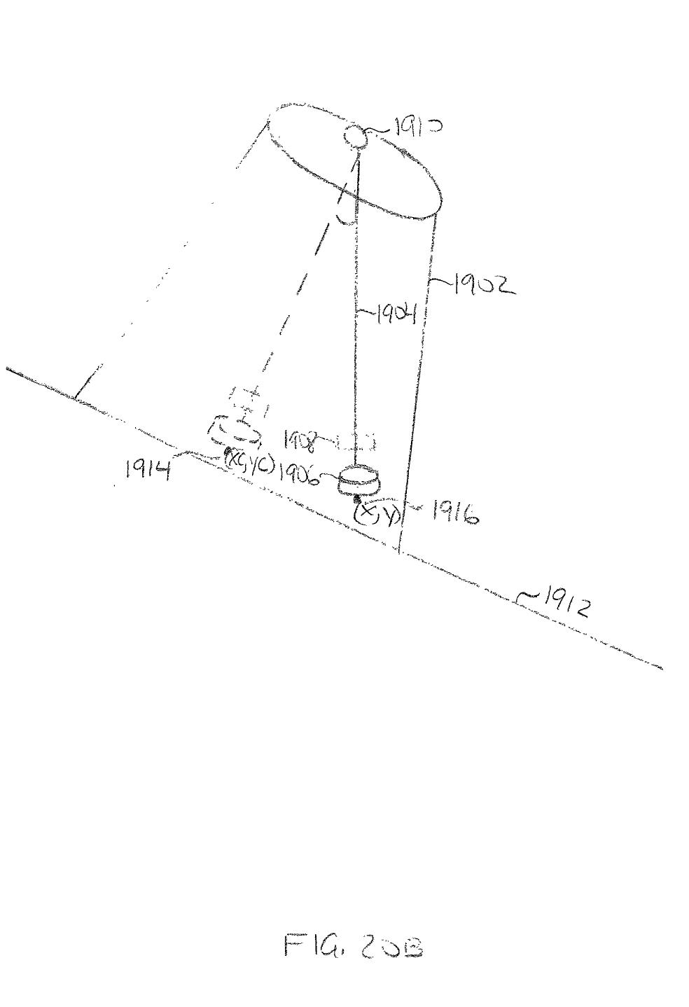

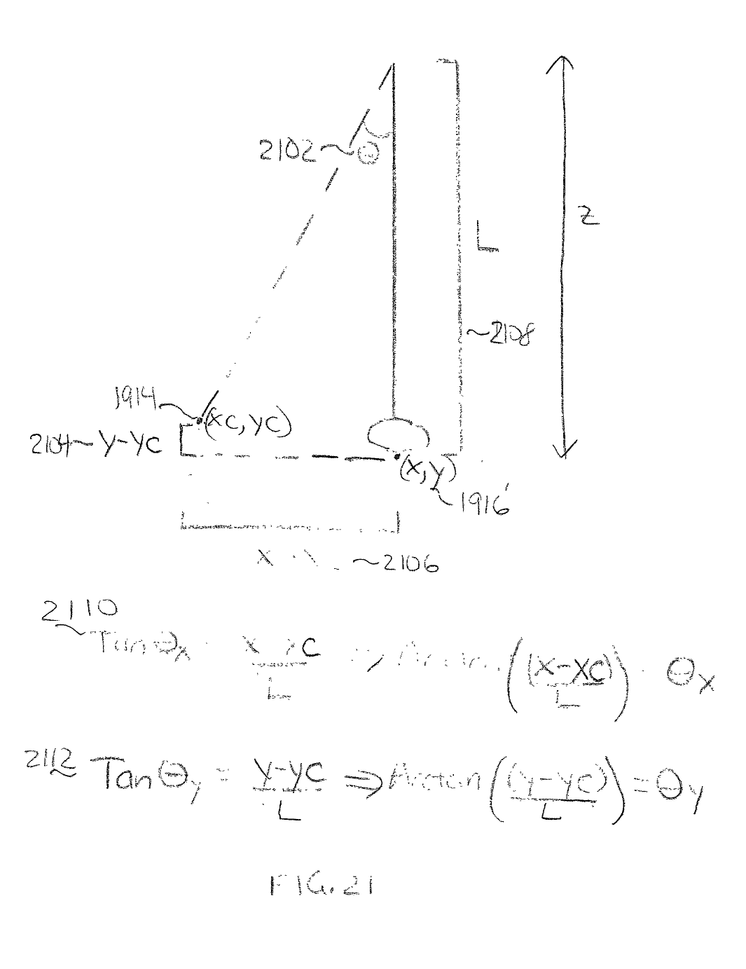

FIG. 20A is a diagram illustrating the use of the rotation detection system of FIG. 19A to determine a coordinate associated with the physical object when the physical object is in a resting state. As shown, when the physical object is in the resting state, the housing for the pendulum causes the puck to hang freely slightly lifted from the platform 1912. When an excitation signal having a suitable frequency is transmitted by an antenna (or separate transmitter) in the platform 1912, the resonator 1906 resonates and transmits a resonator signal that may be received by the antenna itself or a separate receiver in the platform 1912. In this manner, a first coordinate 1914 of the resonator 1906 when the physical object 1902 and the rotation detection object 1904 are both in a resting state may be detected. In other words, the first coordinate 1914 is determined when the physical object 1902 is not being rotated. For instance, when the physical object 1902 is in a resting state, the platform 1912 is substantially flat and the angle of rotation of the physical object 1902 is effectively zero. This first coordinate 1914 may be denoted (xc, yc) as the center point of the pendulum 1904.

FIG. 20B is a diagram illustrating the use of the rotation detection system of FIG. 19A to determine a coordinate associated with the physical object when the physical object is rotated about an axis of rotation. More particularly, a position detection mechanism detects the first coordinate 1914 of the rotation detection object when the rotation detection object is in a first resting position and detects a second coordinate 1916 of the rotation detection object when the rotation detection object is moved to a second non-resting position. For instance, the position detection mechanism may detect a first coordinate of a resonator associated with the rotation detection object when the rotation detection object is in a resting position and a second coordinate of the resonator when the rotation detection object is in a second non-resting position. In this embodiment, when the physical object 1902 is rotated, the platform 1912 is tilted while the rotation detection object 1904 (e.g., pendulum) remains fixed with respect to the ground. In other words, the rotation detection object 1904 maintains a substantially 90 degree angle in relation to the ground while the inclination of the platform 1912 corresponds to the angle of rotation of the physical object 1902. Thus, the first coordinate 1914 and second coordinate 1916 of the rotation detection object are effectively measured in relation to the platform 1912. A rotation detection mechanism then translates movement of the rotation detection object from the first coordinate to the second coordinate to one or more angles of rotation of the physical object. Of course, a third coordinate may then be detected when the physical object is again rotated from the its second coordinate.

The rotation detection mechanism may be implemented in a variety of ways to accommodate a variety of implementations of the rotation detection object. FIG. 21 is a diagram illustrating one mechanism for determining one or more angles of rotation associated with a physical object using the coordinates previously obtained as shown in FIG. 20A and FIG. 20B when the physical object is rotated about an axis of rotation. As shown, one or more angles 2102 of rotation may be determined when the rotation detection object moves from the first resting coordinate 1914 to the second coordinate 1916 in response to a movement (e.g., rotation) of the associated physical object. More particularly, when the rotation detection object moves from the first coordinate 1914 to the second coordinate 1916, the difference in coordinates may be measured in terms of a difference in y-coordinate values 2104 and a difference in x-coordinate values 2106. The difference in y-coordinate values 2104 is equal to the difference between the y-coordinate at the second coordinate 1916 and the y-coordinate at the first coordinate 1914. Similarly, the difference in x-coordinate values 2106 is equal to the difference between the x-coordinate at the second coordinate 1916 and the x- coordinate at the first coordinate 1914.

According to one embodiment, one or more angles of rotation include an angle of rotation with respect to an x-coordinate and an angle of rotation with respect to a y-coordinate. These angles of rotation may be obtained from a length L 2108 of the rotation detection object, the difference in x-coordinate values 2106 and the difference in y-coordinate values 2104. For instance, a first arctangent function 2110 (arctan((x-xc)/L) may be used to obtain an angle of rotation with respect to an x-coordinate while a second arctangent function 2112 (arctan((y-yc)/L) may be used to obtain an angle of rotation with respect to a y-coordinate. The arctangent functions 2110 and 2112 will return a value between −90 and 90 degrees. Although the arctangent function is used in this embodiment to determine one or more angles of rotation, other functions (e.g., arcsin and arccos) may be used in combination with this as well as alternative embodiments of the rotation detection object.

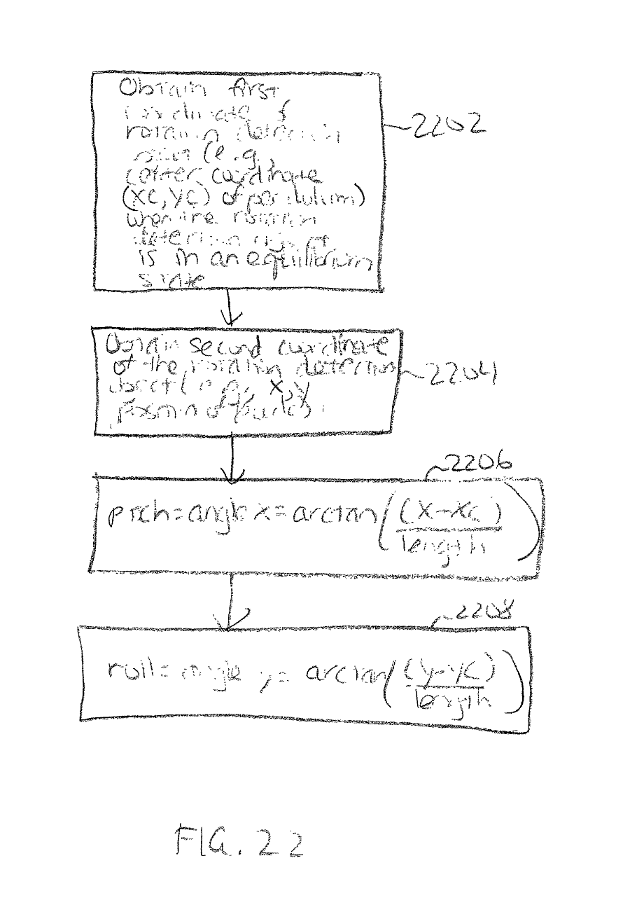

FIG. 22 is a process flow diagram illustrating one method of obtaining one or more angles of rotation of a physical object that is rotated about an axis of rotation as shown in FIG. 20B. In accordance with the pendulum type embodiment, it may be assumed that the housing for the pendulum causes the puck to hang freely slightly lifted from the platform. At block 2202, a first coordinate of the rotation detection object when the rotation detection object is in a resting state is obtained. For instance, a center coordinate (xc, ye) of the pendulum when the pendulum is at rest (e.g., in its equilibrium state) may be obtained. The center coordinate may correspond, for instance, to the puck. This center coordinate may be obtained once and stored for use throughout the use of the rotation detection system of the present invention. During use of the rotation detection system, a second coordinate of the rotation detection object is obtained as shown at block 2204 when the physical object is rotated (e.g., tilted). As described above, the first and second coordinates may be obtained through the use of a resonator which may be affixed, for example, to the puck of the pendulum. Once the coordinates associated with the rotation detection object are obtained, one or more angles of rotation of the physical object may be ascertained as shown at blocks 2206 and 2208. More particularly, an angle of rotation with respect to an x-axis (e.g., pitch) is obtained at block 2206. Similarly, an angle of rotation with respect to a y-axis (e.g., roll) is obtained at block 2208. Although two angles are ascertained with respect to the described embodiment, fewer or greater numbers of angles may be ascertained as necessary in alternative embodiments of the rotation detection system. Once the angles of rotation of the physical object are ascertained, an image of the physical object may similarly be rotated to reflect the movement of the physical object.

As described above, a coordinate of a rotation detection object (e.g., pendulum) in relation to a platform may be determined in order to ascertain an angle of rotation of an associated physical object. However, this is merely exemplary and therefore the platform may be any rotation detection object. Thus, a coordinate of a first rotation detection object (e.g., pendulum, inverted pendulum, disk, resonator, etc.) in relation to a second rotation detection object (e.g., platform, curved or spherical structure, a cavity, or bar) may be obtained in order to ascertain an angle of rotation of a physical object that is coupled to at least one of the rotation detection objects. Of course, an angle of rotation of one of the rotation detection objects (e.g., pendulum) with respect to another one of the rotation detection objects (e.g., platform) and therefore the angle of rotation of the associated physical object may be ascertained by the rotation detection mechanism directly without measuring coordinates of the rotation detection objects.

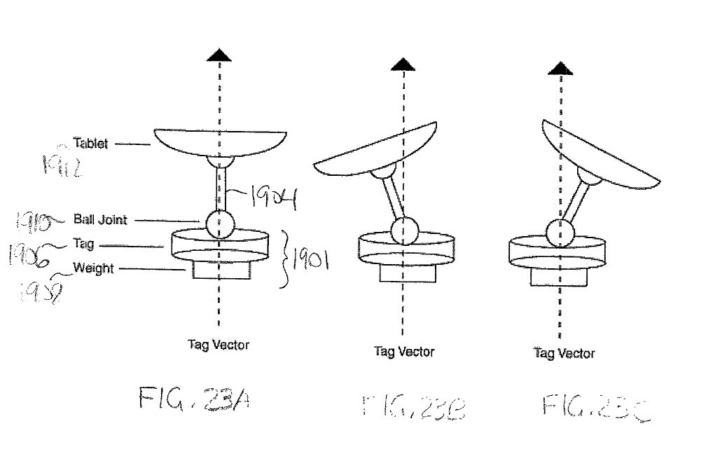

FIG. 23A is a diagram illustrating an inverted pendulum type rotation detection system for detecting an angle of rotation of a physical object in accordance with one embodiment of the invention. The physical object (e.g., housing) may include a resonator 1906 that is arranged to output a resonator signal when an excitation signal with a predetermined frequency range is received by the resonator. In this embodiment, the rotation detection object 1904 is movably coupled to the physical object through a fixed portion 1901 (e.g., another rotation detection object). As shown, the rotation detection object 1904 may be rotatably coupled to the fixed portion 1901 through a ball joint 1910. Thus, the rotation detection object 1904 is moveable among two or more positions in response to gravitational pull. For instance, the rotation detection object 1904 may move in a direction opposite to that of the fixed portion 1901 when the physical object is tilted. The platform 1912 is coupled (e.g., affixed) to the rotation detection object 1904. For instance, the platform 1912 may be affixed to the rotation detection object 1904. As described above, the platform 1912 and therefore the rotation detection object 1904 may include an antenna or transmitter that is arranged to output an excitation signal to the resonator 1906. In addition, a weight 1908 may be used to couple the fixed portion 1901 to the physical object. Although the pendulum type rotation detection object detects movement or tilting of the platform with respect to the pendulum which remains pointed downward toward the ground, the inverted pendulum type rotation detection mechanism detects movement of the pendulum with respect to the platform.

FIG. 23B is a diagram illustrating the rotation detection system of FIG. 23A when the physical object is rotated about an axis of rotation in a first direction. As shown, when the physical object that is coupled to the fixed portion 1901 is rotated, this causes the rotation detection object 1904 to move in response to gravitational pull. The position detection mechanism may include a receiver that is arranged to receive the resonator signal when the transmitter outputs the excitation signal. In this manner, the position detection mechanism may detect a coordinate of the resonator. The rotation detection mechanism then translates the coordinate of the resonator to one or more angles of rotation of the physical object.

FIG. 23C is a diagram illustrating the rotation detection system of FIG. 23A when the physical object is rotated about the axis of rotation in a second direction. As shown, the rotation detection object 1904 moves in response to gravity by rotating upon the ball joint 1910. Accordingly, the rotation detection object 1904 is capable of rotating or sliding upon the fixed portion 1901, enabling a coordinate associated with the rotation detection object 1904 to be obtained. The coordinate may then be translated to one or more angles of rotation identified with the physical object that is coupled to the fixed portion 1901.

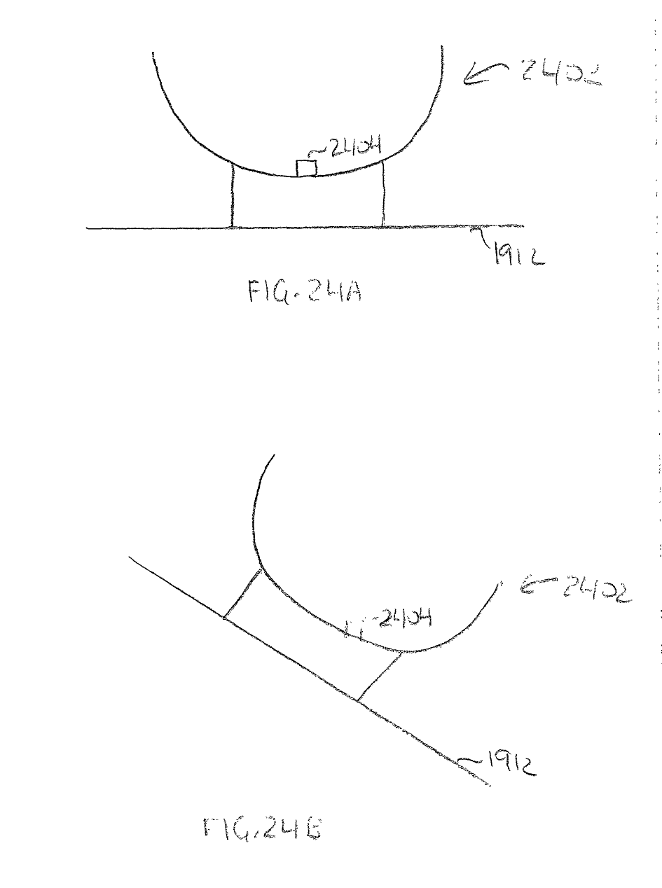

As described above, the rotation detection object may include a detachable portion (e.g., resonator) that is freely movable with respect to the remaining portion of the rotation detection object. The platform (or other appropriate object) is adapted for detecting a position of the detachable portion in relation to the platform. FIG. 24A is a diagram illustrating a bowl type rotation detection system for detecting an angle of rotation (or orientation) of a physical object in accordance with one embodiment of the invention. As shown, a rotation detection object 2402 has a concave surface in which a resonator 2404 is placed. The platform 1912 may be coupled to the physical object.

FIG. 24B is a diagram illustrating the rotation detection system of FIG. 24A when the physical object is rotated about an axis of rotation. As shown, when the physical object is rotated (e.g., tilted), the resonator 2404 moves freely along the surface of the rotation detection object 2404. Thus, through obtaining a first center position of the resonator 2404 when in a resting state (e.g., when the physical object is not being tilted) as well a second position of the resonator 2404 when in a non-resting state after rotation of the physical object, an angle of rotation of the physical object may be obtained.

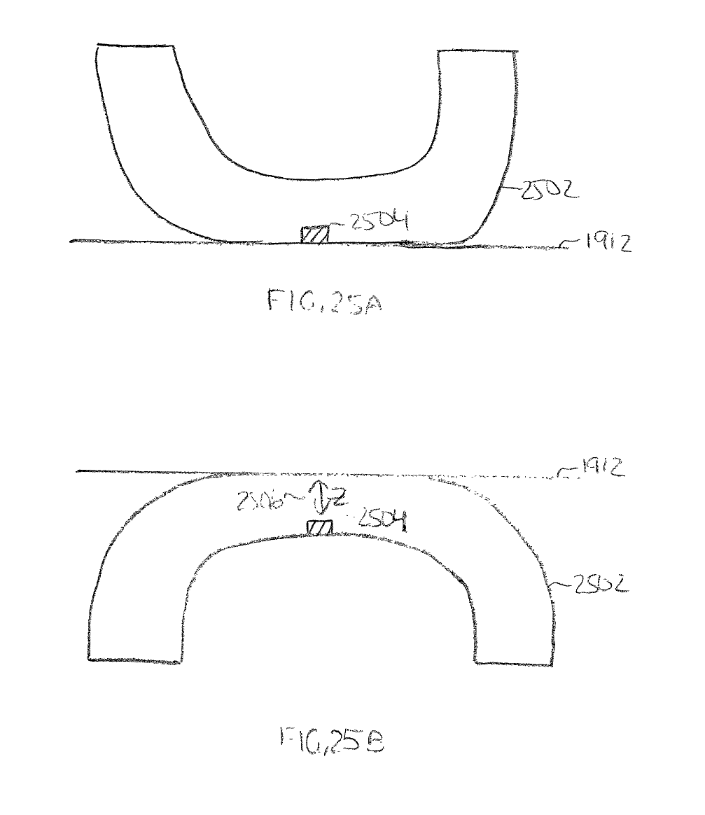

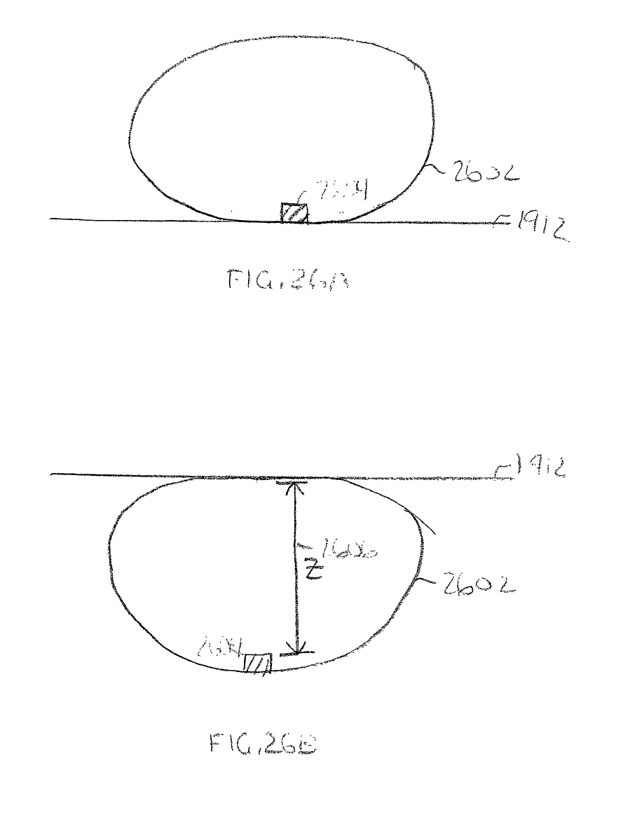

In the embodiments described with reference to FIGS. 25A-25B and 26A-26B, the rotation detection object includes a cavity in which the resonator is placed. FIG. 25A is a diagram illustrating a U-shaped rotation detection system for detecting an angle of rotation of a physical object in accordance with one embodiment of the invention. As shown, rotation detection object 2502 includes a cavity in which a resonator 2504 is placed. Moreover, the cavity preferably has a concave surface. In this embodiment, the cavity as well as the rotation detection object 2502 are substantially U-shaped. However, this example is merely illustrative and alternative shapes for the cavity as well as the rotation detection object 2502 are possible.

FIG. 25B is a diagram illustrating the rotation detection system of FIG. 25A when the physical object is rotated about an axis of rotation. The platform 1912 is preferably coupled to the rotation detection object 2502 as shown. When the physical object is rotated, the rotation detection object 2502 is rotated and the position of the resonator 2504 within the rotation detection object 2502 changes. This change in position may then be detected via a distance 2506 that may be ascertained through a position detection mechanism associated with the platform 1912. For instance, the position detection mechanism may receive a resonator signal from the resonator 2504 which may then be translated into a coordinate.

Any of the above described rotation detection objects may be used to determine an angle of rotation of a physical object. In addition, rather than ascertaining the angle of rotation of the physical object, it may be desirable to merely ascertain an orientation of the physical object. For instance, it may be desirable to ascertain whether the physical object such as the spaceship illustrated in FIG. 18 is located in a center position, has turned left, or turned right.

In addition, it may be desirable to ascertain whether the physical object is upright or, alternatively, whether the physical object has turned upside down. This is particularly desirable in the case of a spaceship such as that illustrated in FIG. 18. FIG. 26A is a diagram illustrating a spherical rotation detection system for detecting an angle of rotation of a physical object in accordance with one embodiment of the invention. As shown, rotation detection object 2602 includes a cavity in which a resonator 2604 is placed. The cavity preferably has a concave surface. In this embodiment, the rotation detection object 2602 is substantially spherical. Thus, the cavity as well as the rotation detection object 2602 may have a spherical or oval shape.

FIG. 26B is a diagram illustrating the rotation detection system of FIG. 26A when the physical object is rotated about an axis of rotation. As described above with reference to FIG. 25B, when the physical object is rotated, the rotation detection object 2602 is rotated and the position of the resonator 2604 within the rotation detection object 2602 changes. This change in position may then be detected via a distance 2606 that may be ascertained through a position detection mechanism associated with the platform 1912. For instance, the position detection mechanism may receive a resonator signal from the resonator 2604 which may then be translated into a coordinate.

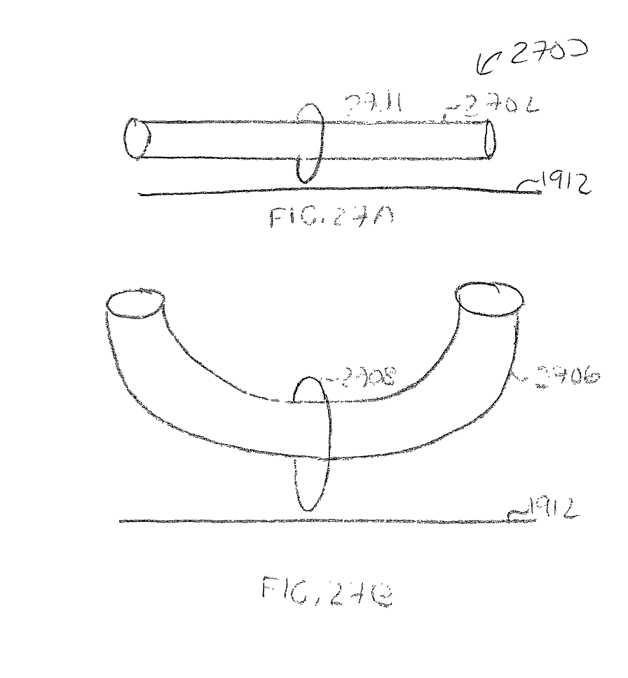

FIG. 27A is a diagram illustrating a donut shaped rotation detection system used in conjunction with an elongated member in accordance with one embodiment of the invention. In this embodiment, the rotation detection object 2700 includes an elongated member and a disk 2704 having a hole disposed therethrough and being slidably coupled to the elongated member 2702. A resonator may be affixed to the disk 2704. Thus, when the position of the resonator is detected, for example, through a receiver in an associated platform, an angle of rotation of the physical object may be obtained.

Although the embodiment illustrated in FIG. 27A shows an elongated member that is substantially straight, the elongated member may have a different shape. FIG. 27B is a diagram illustrating a donut shaped rotation detection system used in conjunction with a curved elongated member in accordance with another embodiment of the invention. As shown, the elongated member 2706 has a curved shape that allows an associated disk and/or resonator 2708 to slide along the elongated member 2706 in response to a rotation of an associated physical object.

Although the foregoing invention has been described in some detail for purposes of clarity of understanding, it will be apparent that certain changes and modifications may be practiced within the scope of the appended claims. For example, each resonator may also be configurable. The user may change the resonator frequency range. Each resonator may be configured with one or more variable capacitor(s) and/or one or more variable inductor(s). Thus, the user changes the capacitor and/or inductance value to affect a change in the resonator frequency values at which the resonator responds to an excitation signal and outputs a resonating frequency. Additionally, although the present invention is described as being implemented with electromagnetic sensing technology, any suitable sensing technology may be implemented, such as a camera based system. As one example, the physical objects may include codes (e.g., bar codes) that are detected by the camera detection system. Mechanisms may then be provided for converting the detected codes into various physical object states, such as the physical object's identity and position.

As another example, identity and movement of the physical objects (and rotation detection objects) may be tracked by a camera such as a video camera. Moreover, although various embodiments are described above, one or more rotation detection objects (e.g., a resonator) may be implemented in a variety of forms in order to detect an angle of rotation, movement, or orientation of an associated physical object using gravity. For instance, the present invention may be used to ascertain that the orientation of a physical object is left, right, center, or upside down. Thus, through the present invention, the movement and angle of a first rotation detection object (e.g., pendulum) in relation to a second rotation detection object (e.g., platform) may detected and tracked through electromagnetic sensing technology or other suitable technology. As one example, a resonator may be coupled to a pendulum or a physical object to enable movement or angle of rotation of the pendulum in relation to another rotation detection object such as a platform to be detected and measured. As another example, the resonator may be coupled to the platform. Additionally, the rotation detection mechanisms described with reference to FIGS. 18 through 24B may be combined with any other suitable translation mechanism as described with reference to FIGS. 4 through 17 to determine other object states, in addition to rotation.

Moreover, although the above described embodiments illustrate the use of a platform in combination with a resonator, a position of a first detection object in relation to a second detection object may be ascertained through a variety of mechanisms, including but not limited to, a camera detection system. Accordingly, the present embodiments are to be considered as illustrative and not restrictive, and the invention is not to be limited to the details given herein, but may be modified within the scope and equivalents of the appended claims.

What is claimed is:

1. A rotation detection system for detecting an angle of rotation of a physical object, comprising:
a rotation detection object adapted for being movably coupled to a physical object, at least a portion of the rotation detection object being moveable among two or more positions in relation to the physical object in response to gravitational pull; and
a rotation detection mechanism for detecting one or more angles of rotation of the physical object when the at least a portion of the rotation detection object moves from a first one of the two or more positions to a second one of the two or more positions.

2. The rotation detection system as recited in claim 1, further including:
a position detection mechanism for detecting a position of the rotation detection object;
wherein the rotation detection mechanism translates the position of the rotation detection object to one or more angles of rotation of the physical object.

3. The rotation detection system as recited in claim 2, wherein the rotation detection object is a pendulum.

4. The rotation detection system as recited in claim 2, wherein the rotation detection object includes a resonator that is arranged to output a resonator signal when an excitation signal with a predetermined frequency range is received by the resonator, wherein the rotation detection system further includes a transmitter for outputting the excitation signal to the resonator, and the position detection mechanism includes a receiver that is arranged to receive the resonator signal to enable the position detection mechanism to translate the resonator signal to the position of the rotation detection object.

5. The rotation detection system as recited in claim 2, wherein the physical object includes a resonator that is arranged to output a resonator signal when an excitation signal with a predetermined frequency range is received by the resonator, the rotation detection object includes a transmitter for outputting the excitation signal to the resonator, and the position detection mechanism includes a receiver that is arranged to receive the resonator signal and translate the resonator signal to the position of the rotation detection object.

6. A rotation detection system for detecting an orientation of a physical object, comprising:
a rotation detection object adapted for being movably coupled to a physical object, at least a portion of the rotation detection object being moveable among two or more positions in relation to the physical object in response to gravitational pull; and
a rotation detection mechanism for detecting an orientation of the physical object when the at least a portion of the rotation detection object moves from a first one of the two or more positions to a second one of the two or more positions.

7. The rotation detection system as recited in claim 6, wherein the orientation indicates that the physical object is at least one of centered, turned left, turned right, upright, or upside down.

8. A rotation detection system for detection an orientation of a physical object, comprising:
a first rotation detection object;
a second rotation detection object, at least a portion of the second rotation detection object being moveable among two or more positions in relation to the first rotation detection object in response to gravitational pull when the physical object is rotated about an axis of rotation; and
a detection mechanism for detecting an orientation of the physical object from the movement of the at least a portion of the second rotation detection object in relation to the first rotation detection object.

9. The rotation detection system as recited in claim 8, wherein the first rotation detection object is adapted for being coupled to the physical object such that the first rotation detection object rotates with the physical object when the physical object is rotated about the axis of rotation, and the second rotation detection object maintains an angle that is fixed with respect to the ground.

10. The rotation detection system as recited in claim 9, wherein the second rotation detection object maintains an angle that is substantially 90 degrees with respect to the ground.

11. The rotation detection system as recited in claim 8, wherein the first rotation detection object is adapted for being coupled to the physical object such that the first rotation detection object rotates with the physical object when the physical object is rotated about the axis of rotation, and the second rotation detection object moves in relation to the first rotation detection object in response to gravity.

12. The rotation detection system as recited in claim 8, wherein the orientation indicates that the physical object has at least one of turned left, turned right, remains in an original position, remains upright, or has turned upside down

13. The rotation detection system as recited in claim 8, wherein the orientation indicates that the physical object has at least one of tilted left, has tilted right, has tilted forward, or has tilted backward.

14. The rotation detection system as recited in claim 8, wherein the second rotation detection object is rotatably coupled to the first rotation detection object, the first rotation detection object being capable of detecting a position of the second rotation detection object in relation to the first rotation detection object.

15. The rotation detection system as recited in claim 8, wherein the second rotation detection object includes a first end and a second end, the first end being rotatably coupled to the first rotation detection object, the first rotation detection object being capable of detecting a position of the second end of the second rotation detection object in relation to the first rotation detection object.

16. The rotation detection system as recited in claim 8, wherein the second rotation detection object is a pendulum.

17. The rotation detection system as recited in claim 8, wherein the first rotation detection object and the second rotation detection object together form a pendulum.

18. The rotation detection system as recited in claim 8, wherein the second rotation detection object includes an elongated member and a disk having a hole disposed therethrough and being adapted for sliding along the elongated member, the first rotation detection object being capable of detecting a position of the disk in relation to the first rotation detection object.

19. The rotation detection system as recited in claim 18, wherein the elongated member is curved.

20. The rotation detection system as recited in claim 18, wherein the elongated member is substantially straight.

21. The rotation detection system as recited in claim 8, wherein the second rotation detection object includes a detachable portion, the second rotation detection object having a concave surface in which the detachable portion is placed, the first rotation detection object being adapted for detecting a position of the detachable portion in relation to the first rotation detection object.

22. The rotation detection system as recited in claim 21, wherein the resonator changes its position along the concave surface when the physical object is rotated.

23. The rotation detection system as recited in claim 8, wherein the second rotation detection object includes a detachable portion, the second rotation detection object having a cavity in which the detachable portion is placed, the rotation detection system being adapted for detecting a position of the detachable portion in relation to the first rotation detection object.

24. The rotation detection system as recited in claim 23, wherein the cavity is substantially U-shaped.

25. The rotation detection system as recited in claim 23, wherein the cavity is substantially spherical.

26. The rotation detection system as recited in claim 23, wherein the first rotation detection object is adapted for detecting a position of the detachable portion in relation to the first rotation detection object.

27. The rotation detection system as recited in claim 23, wherein the detachable portion changes its position within the cavity when the physical object is rotated about an axis of rotation.

28. A rotation detection system for detection an angle of rotation of a physical object, comprising:
a first rotation detection object;
a second rotation detection object, at least a portion of the second rotation detection object being moveable among two or more positions in relation to the first rotation detection object in response to gravitational pull when the physical object is rotated about an axis of rotation; and
a rotation detection mechanism for detecting one or more angles of rotation of the physical object from the movement of the at least a portion of the second rotation detection object in relation to the first rotation detection object.

29. The rotation detection system as recited in claim 28, further including a position detection mechanism that detects a first coordinate of the second rotation detection object in relation to the first rotation detection object when the first rotation detection object is in a resting position and detects a second coordinate of the second rotation detection object in relation to the first rotation detection object when the first rotation detection object is tilted to a second non-resting position, and wherein the rotation detection mechanism is arranged to translate movement of the second rotation detection object from the first coordinate to the second coordinate to the one or more angles of rotation of the physical object.

30. The rotation detection system as recited in claim 28, wherein the one or more angles of rotation include at least one of an angle of rotation with respect to an x-coordinate and an angle of rotation with respect to a y-coordinate.

31. The rotation detection system as recited in claim 28, wherein the one or more angles of rotation are determined using a length of the second rotation detection object.

32. The rotation detection system as recited in claim 28, further including a position detection mechanism that detects a first coordinate of the second rotation detection object in relation to the first rotation detection object when the second rotation detection object is in a resting position and detects a second coordinate of the second rotation detection object in relation to the first rotation detection object when the second rotation detection object is moved to a second non-resting position, and wherein the rotation detection mechanism is arranged to translate movement of the second rotation detection object from the first coordinate to the second coordinate to the one or more angles of rotation of the physical object.

33. The rotation detection system as recited in claim 28, wherein the second rotation detection object moves in relation to the first rotation detection object in response to gravity and wherein the first rotation detection object includes a resonator and the second rotation detection object includes a platform arranged to output an excitation signal to the resonator, the rotation detection system further including a position detection mechanism for detecting a position of the resonator in relation to the platform when the platform outputs the excitation signal, wherein the rotation detection mechanism translates the position of the resonator to one or more angles of rotation of the physical object.

34. The rotation detection system as recited in claim 28, wherein the second rotation detection object includes a resonator and the first rotation detection object is a platform arranged to output an excitation signal to the resonator, the rotation detection system further including a position detection mechanism for detecting a position of the resonator in relation to the platform when the platform outputs the excitation signal, wherein the rotation detection mechanism translates the position of the resonator to one or more angles of rotation of the physical object.

35. The rotation detection system as recited in claim 34, wherein the second rotation detection object includes a first end and a second end, the first end being rotatably coupled to the first rotation detection object and the second end having the resonator affixed thereto.

36. The rotation detection system as recited in claim 34, wherein the second rotation detection object includes an elongated member and a disk having a hole disposed therethrough and being slidably coupled to the elongated member, wherein the resonator is affixed to the disk.

37. The rotation detection system as recited in claim 34, wherein the second rotation detection object has a concave surface in which the resonator is placed.

38. The rotation detection system as recited in claim 34, wherein the second rotation detection object includes a cavity in which the resonator is placed.

39. A method of detecting an angle of rotation of a physical object, comprising:
detecting a first position of a second object in relation to a first object when the physical object is in a first location, the second object being moveable among two or more positions in relation to the first object in response to gravitational pull when the physical object is rotated about an axis of rotation;
detecting movement of the second object in relation to the first object from the first position to a second position when the physical object is in a second location upon being rotated about the axis of rotation; and
ascertaining an orientation of the physical object from the movement of the second object in relation to the first object.

40. The method as recited in claim 39, wherein ascertaining an orientation of the physical object includes ascertaining one or more angles of rotation of the physical object.

41. The method as recited in claim 40, further comprising:
rotating an image of the physical object corresponding to the one or more angles of rotation of the physical object.

42. The method as recited in claim 39, further comprising:
modifying an image of the physical object on a display to illustrate the orientation of the physical object.
